(19) United States
(12) Patent Application Publication
(10) Pub. No.: US 2026/0236685 A1
(43) Pub. Date: Aug. 13, 2026

(54) HIERARCHICAL TOPIC GENERATION AND LABELING USING LARGE LANGUAGE MODELS

(71) Applicant: HUBSPOT, INC., Cambridge, MA (US)

(72) Inventors: Christopher James AGOSTINO, Bloomington, IN (US); Matthew Stephen CORRITORE, San Francisco, CA (US); Emily Samantha REIT, San Diego, CA (US); Iman JEAN-JACQUES, Miramar, FL (US)

(21) Appl. No.: 19/052,714

(22) Filed: Feb. 13, 2025

(51) Int. Cl. G06F 40/30; G06Q 30/01

(52) U.S. Cl. CPC G06F 40/30; G06Q 30/01

(57) ABSTRACT

Systems and methods are provided for hierarchical topic generation using large language models. A large langue model is invoked to generate initial topics for content of a corpus. An iterative process is performed to identify, merge, and/or remove overlapping topics to create a refined set of topics. Topics within the refined set of topics are assigned to components of the content. Multiple topics may be assigned to a single document. The large language model is invoked to iteratively assign subtopics to the content. The topics and subtopics are arranged into a hierarchical topic structure used to generate and/or execute an analysis result.

### BACKGROUND

Topic models are used to identify thematic ideas from free text. For example, a topic model may be used to identify a topic of a document. The topic model may implement natural language processing (NLP) workflows to identify topics of documents within a corpus of documents. The topic model may utilize underlying word embeddings to identify components (portions of text) that are similar based upon the components being close in embedding space. Unfortunately, topic models over index on linguistic similarity, such as over indexing on language and words of the components. For example, the corpus may include two survey responses that both relate to work/life balance. One of the survey responses may include language talking about burnout, while the other survey response may include language talking about stress at work. Even though the two survey responses both relate to the same topic of work/life balance, the topic model may separate the survey responses into two different topics about burnout and about work stress.

### DESCRIPTION OF THE DRAWINGS

Embodiments of the present technology will be described and explained through the use of the accompanying drawings in which:

FIG. 1 is a block diagram illustrating an embodiment of a system for hierarchical topic generation using large language models, in accordance with an embodiment of the present technology.

FIG. 2 is a flow chart illustrating an embodiment of a method for hierarchical topic generation using large language models, in accordance with an embodiment of the present technology.

FIG. 3A is a block diagram illustrating an embodiment of a system for hierarchical topic generation using large language models, in accordance with an embodiment of the present technology.

FIG. 3B is a block diagram illustrating an embodiment of a workflow, in accordance with an embodiment of the present technology.

FIG. 3C is a block diagram illustrating an embodiment of a prompt, in accordance with an embodiment of the present technology.

FIG. 3D is a block diagram illustrating an embodiment of a prompt for generating a topic, in accordance with an embodiment of the present technology.

FIG. 3E is a block diagram illustrating an embodiment of a prompt for generating subtopics, in accordance with an embodiment of the present technology.

FIG. 3F is a block diagram illustrating an embodiment of topic assignment, in accordance with an embodiment of the present technology.

FIG. 3G is a block diagram illustrating an embodiment of multi-subtopic assignment, in accordance with an embodiment of the present technology.

FIG. 3H is a block diagram illustrating an embodiment of a hierarchical topic structure, in accordance with an embodiment of the present technology.

FIGS. 4A-4N are a block diagrams illustrating embodiments of analysis results, in accordance with an embodiment of the present technology.

FIG. 5 is an example of a computer readable medium in which an embodiment of the present technology may be implemented.

FIG. 6 illustrates an exemplary computing environment wherein one or more of the provisions set forth herein may be implemented.

FIG. 7 illustrates an exemplary multi-service business platform wherein one or more of the provisions set forth herein may be implemented.

The drawings have not necessarily been drawn to scale. Similarly, some components and/or operations may be separated into different blocks or combined into a single block for the purposes of discussion of some embodiments of the present technology. Moreover, while the present technology is amenable to various modifications and alternative forms, specific embodiments have been shown by way of example in the drawings and are described in detail below. The intention, however, is not to limit the present technology to the particular embodiments described. On the contrary, the present technology is intended to cover all modifications, equivalents, and alternatives falling within the scope of the present technology as defined by the appended claims.

### DETAILED DESCRIPTION

Systems and methods are provided for hierarchical topic generation utilizing large language models (LLMs) using a topic-activated document exploration framework. In particular, the framework is implemented for hierarchical topic modeling. The framework utilizes large language models to dynamically reveal and extract content (e.g., document content or content extracted from emails, chats, surveys, call transcripts, websites, information stored within objects of a customer relationship management database of a multi-service business platform, etc.) across various levels of thematic granularity. The framework provides intelligent and semantic extraction of components, such as document components of text, relevant to topics identified for documents of a corpus.

The framework improves upon conventional topic modeling that requires rules-based pre-segmentation of the corpus or documents into chunks in order to generate assigned topics with some level of accuracy. Conventional topic modeling often results in the generation of spurious topics that are not truly representative of the document's content. Also, conventional topic modeling uses topic models that over index on linguistic similarity, such as over indexing on language and words of the components.

The framework allows for direct alignment with relevant content, resulting in more accurate topic assignments compared to conventional topic modeling. To support intelligent assignment and extraction, the framework uses situational context and employs a pseudo-chain of thought approach for prompting the LLM with instructions to justify topic assignments. This leads to topic assignments that are more accurate and contextually aware than traditional BERT-based topic models. Additionally, because the framework is capable of assigning multiple topics to different components, the framework enables users to more easily explore theme intersections and relatedness by exploring the co-occurrence of different topics within a same document. Furthermore, the framework incorporates methods for examining the subtopics of a given topic. These subtopics and the final topic assignments are generated with the main topic and relevant context in mind. This facilitates more meaningful subtopics and appropriate subtopic assignments. The framework improves upon conventional BERT-based topic modeling in terms of coherence, transparency, flexibility, and explainability. By leveraging the latent semantic understanding of LLMs, the framework presents a powerful, context-aware methodology for navigating complex corpora.

The framework harnesses the multi-faceted power of LLMs in a staged, hierarchical process. The framework dynamically extracts document components that are relevant to identified topics, ensuring that text is segmented merely when a topic's presence is concretely identified.

The framework implements a multi-stage process. The multi-stage process includes a first stage where initial topics are generated across the corpus. The multi-stage process includes a second stage where the topics are refined to ensure distinctiveness. The multi-stage process includes a third stage that assigns topics and extracts components, such as where topics are assigned to documents, and relevant text segments are extracted. The multi-stage process includes a fourth stage that includes an iterative hierarchical subtopic discovery, such as where subtopics are derived from macro topics, and further subdivisions are explored. In some embodiments, each stage may be performed using an LLM, and additional user-provided context can be provided to the LLM about a nature of an expected response (e.g., ‘this is a response from a survey of employees at a tech company’, ‘this is a legal brief about a case involving a contract dispute’, etc.).

The framework may provide multi-topic assignments per document. Documents frequently cross thematic boundaries. The framework accommodates such overlap by allowing multiple topics (and sub-levels of subtopics) to be assigned to a single document. This is particularly useful when analyzing complex corpora where different themes intersect or coexist. With the framework, topics activate ‘components’ in the documents (e.g., a sub-clause of a sentence), enabling a targeted extraction of the text segments in the documents that are actually relevant to the topic itself. For a sentence “its hard to get work done at this company because my teammates are in different locations and I don't have enough vacation time to facilitate rest,” then the relevant component for the topic of “vacations” would be “I don't have enough vacation time to facilitate rest.” Extraction is performed for each component in a document related to that topic. For example, if the sentence was part of a larger paragraph about working conditions, and other parts related to vacations or PTO, then those would be extracted in the relevant components for the optic of “vacations.”

In this way, documents can be labeled with multiple topics, and thus the extracted segments will be less bloated with irrelevant text. This makes topics more relevant, useful, practical, and consume less storage space and less compute by not storing and processing irrelevant topics/text. The multi-topic assignment by the framework is different than conventional topic modeling where whole documents receive singular labels, ignoring the multi-faceted nature of language and the potential for multiple topics to be present in a single document.

The hierarchical topic structure provided by the framework is extensible. After macro topics are assigned, each topic can spawn its own subtopics (and so forth). This process continues at any depth to capture finer nuances. For instance, a “Corporate Care” topic may spawn subtopics related to healthcare policies, stakeholder engagement, or financial oversight within that domain.

In some embodiments, the multi-stage process includes the following computer implemented algorithm:
1: Input: Document corpus D
2: Output: Hierarchical structure H of topics and their assigned components.
3: Stage 1: Generate Initial Topics
4: T←GenerateTopics(D) {Generate and refine a set of high-level (macro) topics across the corpus.}
5: Stage 2: Refine Topics
6: T*←RefineTopics(T) {Merge/prune overlapping topics until distinct}
7: Stage 3: Assign Topics and Extract Components
8: for each document d∈D do
9: A(d)←AssignAndExtract(d, T*) {Identify which topics apply to d, extract relevant text segments, and provide LLM-generated explanations & confidence scores}
10: end for
11: Stage 4: Hierarchical Subtopic Discovery (Iterative) {For each macro topic, derive subtopics (and further subdivisions if needed) from its filtered text.}
12: for each topic t∈T* do
13: Dt ←AllRelevantComponents(t) {Collect the extracted components for topic t across all documents}
14: St ←GenerateTopics(Dt) {Propose subtopics (or sub-subtopics, and so on) within t}
15: S*t ←RefineTopics(St)
16: AssignAndExtract(Dt, S*t) {Repeat assignment & extraction specifically within these components}
17: (Optional): If further subdivision is needed, repeat Stage 4 for each newly derived sub topic in S*t
18: end for
19: return H={T*, S*t, . . . }.

The framework increases trust because the algorithm provides LLM explanations and confidence stores. The framework provides the ability to see how a document can belong to multiple themes. The framework reduces fragmentation of text, thus preserving narrative flow when analyzing large documents.

In some embodiments, the framework analyzes responses to system usability surveys, engineering infrastructure surveys, employee net promotor score surveys, and/or other content/documents filled out by users. The framework evaluates and analyzes free-text data, including customer feedback, social media posts, manuscript contents, etc. The framework may provide user friendly natural language processing as a service for users to better understand and leverage their own free-text (e.g., chats, emails, call transcripts, documentation, surveys, information stored within a customer relationship management database, etc.) to generate insights contained within their own user data (e.g., what are customers requesting, complaining about, products and services used by the customers, customer trends and patterns, etc.).

The framework is a comprehensive framework that leverages LLMs to perform advanced concept modeling on textual data. The framework automates the process of identifying and assigning topics to text components, such as survey responses and customer feedback, using context-aware techniques. The framework supports multi-level topic assignments, distinguishing between macro and subtopics, and incorporates iterative refinement through evaluation metrics.

The framework improves upon conventional topic modeling by automating the process of topic modeling and assignment with a greater assignment completeness and reliability than conventional clustering methods. The framework enhances assignment accuracy through semantic assignment and context inclusion. The framework facilitates the discovery of patterns and trends in large volumes of text data. The framework provides more granularity and utility in the subtopic space by restricting subtopic generation to the components that were relevant to the assigned macro topics. Thus, the framework provides users with the ability to obtain a high level overview with macro topics so that the users can identify important themes that traditional topic models would miss because of how noisy the topic space is when including many disparate documents.

The framework provides integration of LLMs for context-aware topic generation, refinement, and assignment. The framework provides the ability to generate topics and subtopics, or to work with pre-designated labels. The framework provides a multi-level topic assignment strategy. The framework provides the ability to associate documents with multiple concepts or topics, allowing for further study of the interrelatedness between topics and their co-occurrence. The framework provides iterative refinement through semantic reduction. The framework extracts components from documents which are relevant to the topic, thus providing a more refined view of specific pieces of text that relate to the topic.

The framework is highly flexible and provides high accuracy and precision in topic categorization and assignment. The framework provides the ability to uncover nuanced language patterns and trends. The framework uses iterative refinement and context-aware techniques to ensure precise topic assignments, which can provide more detailed insights compared to conventional approaches. The framework provides for multi-level analysis through topic assignment and subtopic generation, which allows users to identify the broad themes (macro topics) while also capturing the sub-themes (subtopics) that feed into and inform the analytical context. The framework provides unsupervised or supervised training and execution. The framework provides optical transport to assign documents to topics, which involves an algorithm to minimize the cost of assigning documents to predefined labels. The framework provides advanced capabilities and conceptual modeling capabilities using custom tailored language and prompts for controlling the LLMs.

The framework utilizes LLMs and high-level business context provided by the user to generate topics relevant to the documents and to the business. The framework employs a multi-level topic assignment strategy to categorize text into macro topics and subtopics. The framework includes data preprocessing techniques, such as text cleaning and punctuation removal, to prepare data for analysis. The framework can evaluate topics dynamically to remove redundancies and to ensure the highest quality results.

In some embodiments, the graph includes a macro topic of “benefits and compensation.” Subtopics may include 401k, vacation, and parental leave. A subtopic may have its own subtopics like 401k vesting schedule and 401k contribution limits for the subtopic of 401k.

In some embodiments, the framework is implemented as a hierarchical topic modeling framework using LLMs to dynamically identify, extract, and organize document content across multiple levels of thematic granularity. Unlike conventional topic modeling approaches, the framework segments documents after concrete topic identification and allows multiple topic assignments per document, while additionally providing explanations and confidence scores for the decisions through chain-of-thought reasoning.

In addition, various embodiments of the present technology provide for a wide range of technical effects, advantages, and/or improvements to computing systems and components. For example, various embodiments may include one or more of the following technical effects, advantages, and/or improvements: 1) a method for dynamic document segmentation based on topic activation, rather than pre-defined chunking; 2) a system for hierarchical topic discovery that maintains contextual awareness across levels; 3) a method for multi-topic assignment with targeted component extraction; 4) a system for providing explanatory justification for topic assignments using LLM chain-of-thought reasoning; 5) a method for context-aware subtopic generation that considers parent topics; 6) a system for confidence scoring of topic assignments with explanatory feedback; and/or 7) a method for iterative topic refinement and merging to ensure topic distinctiveness.

In some embodiments, the framework provides for dynamically designed user applications. In particular, the framework automatically tracks and evolves the features of a website/application based on the user preferences that the framework learns as the user utilizes the framework to process documents, and generate and execute analysis results. In some embodiments, the framework generates the hierarchical topic structure as a graph of knowledge about a given system, which is evolved using LLMs.

In some embodiments, the framework provides for temporal topic evolution tracking such as by using the graph/hierarchical topic structure. In particular, the framework utilizes a time dimension, and tracks how topics emerge, merge, split, and evolve over time. The framework could identify emerging trends and predict future topic developments based on historical patterns

In some embodiments, the framework provides for multi-model topic mapping such as by using the graph/hierarchical topic structure. In particular, the framework is configured to analyze images, video transcripts, and audio content simultaneously. The framework creates unified topic hierarchies that bridge different types of media while maintaining context.

In some embodiments, the framework provides for semantic search enhancement such as by using the graph/hierarchical topic structure. In particular, the framework uses the hierarchical topic structure to improve search relevance by understanding context at multiple levels. The framework enables “topic-aware” search that will intelligently incorporate information from surrounding/related topics.

In some embodiments, the framework provides for generative topic inference such as by using the graph/hierarchical topic structure. Given the occurrence of topics within a corpus, the framework could generate other related topics that appear to be missing. The generated topics could be used as an angle/consideration for further understanding the contents of the corpus. The framework not only identifies existing topics, but generates potential “missing” topics. The framework predicts theoretical topics that should exist based on pattern analysis. The framework could identify knowledge gaps or unexplored conceptual areas.

In some embodiments, the framework provides for topic relations such as by using the graph/hierarchical topic structure. In particular, the framework investigates links between seemingly unrelated topics. The framework identifies hidden correlations across vast semantic distances (e.g., large distances within a semantic space, such as between carbohydrates and marathon training).

In some embodiments, the framework provides for analyzing company surveys, such as engineering infrastructure surveys, systems usability surveys, and employee net promotor score surveys.

In some embodiments, the framework provides for analyzing call transcripts, emails, support tickets, and/or other data streams.

In some embodiments, the framework provides for analyzing information related to content associated with a customer for describing and understanding the customer's journey (e.g., a journey of the customer visiting a website, viewing web pages, filling out a form, receiving a marketing email, creating a social network post asking about a product or service, and/or other actions related to a customer potentially purchasing the product or service). The framework may analyze such data to identify factors that led to customers cancelling (e.g., customers email that a feature was not working before cancelling, customers contacting sales for a better price before cancelling, etc.).

In some embodiments, the framework is integrated into a multi-service business platform for enhancing a customer relationship management (CRM) system. The framework may provide for contact intelligence. In particular, the framework analyzes customer communications (e.g., emails, chat logs, call transcripts, etc.) to identify key topics and concerns. The framework may create hierarchical topic maps of customer interactions to understand relationship evolution and evolution of needs over time. For example, a bank user may want to provide users with insight into spending habits. A user could provide transaction history information, which is used to build a hierarchical topic model. The user may be provided with a report where spending statistics are provided for 4 primary categories of “Self-care,” “Entertainment,” “Groceries,” and “Travel,” and the platform can break these down automatically into subcategories such as where Travel might contain “gasoline,” “flights,” “bus,” “train,” etc. or Self-Care might contain “beauty products” or “massages.” The framework generates dynamic contact profiles based on identified topics of interest. The framework predicts future customer needs based on topic patterns.

In some embodiments, the framework is integrated into a multi-service business platform for enhancing a content management system. The framework may provide for smart content organization. The framework automatically categorizes and tags blog posts and website content. The framework creates dynamic content hierarchies based on topic relationships. The framework suggests content gaps based on generative topic inference. The framework enables semantic search across content library. The framework may provide for content performance analytics, and tracks topic performance over time. The framework identifies trending topics and predicts future content opportunities. The framework maps content journey paths based on topic relationships.

In some embodiments, the framework is integrated into a multi-service business platform for enhancing marking hub applications. The framework may provide for campaign intelligence. The framework analyzes campaign performance through topic-based lens. For example, the framework identifies the most engaging topics across different audience segments. The framework generates topic-based content recommendations. The framework maps competitor content topics to identify opportunities. The framework may provide for email marketing enhancement. The framework generates dynamic email content based on recipient's topic interests, and provides for subject line optimization using topic performance data such as by generating subject lines for emails. The framework generates personalized content journeys based on topic engagement (e.g., the framework generates videos, images, descriptions, website content, emails, blogs, or other content that is tailored to topics of interest for a particular user).

In some embodiments, the framework is integrated into a multi-service business platform for service hub implementation. The framework may provide for survey analysis. Users can utilize the framework to analyze surveys that the users conducted to gain valuable insights from text data. The framework may provide for knowledge base optimizations. For example, the framework organizes support documentation using hierarchical topic modeling. The framework identifies knowledge gaps using generative topic inference. The framework creates dynamic FAQ structures based on customer queries. The framework enables context-aware search across support materials, such as ticket analysis. For example, the framework categorizes support tickets using multi-topic assignment. The framework tracks emerging support issues through temporal topic evolution. The framework generates topic-based routing rules for support teams, such as for routing tickets to certain support team members.

In some embodiments, the framework is integrated into a multi-service business platform for enhancing sales hub integration. The framework analyzes sales calls, and generates topic-based sales insights tailored to individual customers. The framework creates dynamic sales playbooks based on successful topic patterns (e.g., what topics were discussed or content having certain topics were provided to a user that ended up purchasing a product or service). The framework predicts deal outcomes based on topic coverage

In some embodiments, the framework is integrated into a multi-service business platform for enhancing operations hub applications. The framework may provide for workflow automation. For example, the framework creates topic-triggered automation workflows. The framework performs dynamic data routing based on topic classification. The framework performs automated report generation based on topic importance. The framework may provide for data quality management, and topic-based data validation. The framework identifies data gaps using topic modeling. The framework provides automated data enrichment based on topic context.

In some embodiments, the framework provides for natural language processing as a service for users. The framework supports REST APIs that the users can call for natural language processing. The framework provides a chat UI through which users can provide documents and run the functionality provided by the framework.

In some embodiments, the framework provides cross-platform features. The framework provides for search enhancement. For example, the framework provides a unified semantic search across multiple applications and services such as services of the multi-service business platform. The framework provides topic-aware query understanding. The framework provides contextual search suggestions. The framework provides for analytics integration. The framework provides for cross-platform topic tracking, such as topics associated with content hosted by various applications and services (e.g., topics discussed in support tickets, topics described in content generated or used by workflows, topics of content within blogs, topics of content stored within objects of a CRM database, topics within content associated with deals and customers, etc.). The framework provides for topic-based return on investment analysis. The framework provides for predictive analytics using topic patterns. In this way, the framework implements hierarchical topic generation using large language models for various use cases.

In some embodiments, the platform generates labels on training data in a hierarchical manner. A compressed concept map is created for corpuses (e.g., corpuses of image captions), which can be used to train a model (e.g., a small and effective diffusion model; a video-based model; etc.) in a resource efficient manner. The platform may generate labels and/or use a compressed concept map to perform other generative AI tasks. In this way, the platform may compress model parameters, which substantially reduces training and inference compute, and thus the platform can be implemented as part of a natural language processing as a service suite.

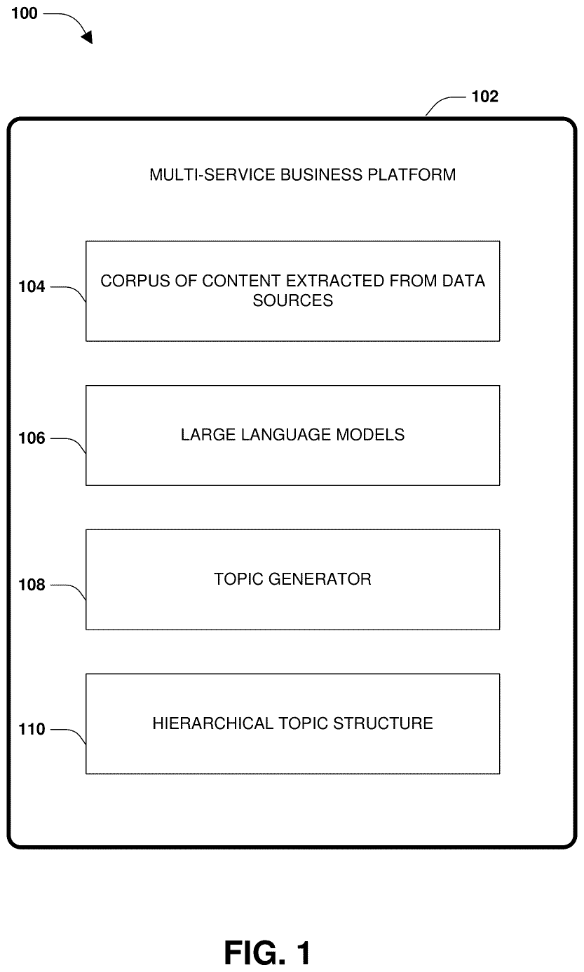

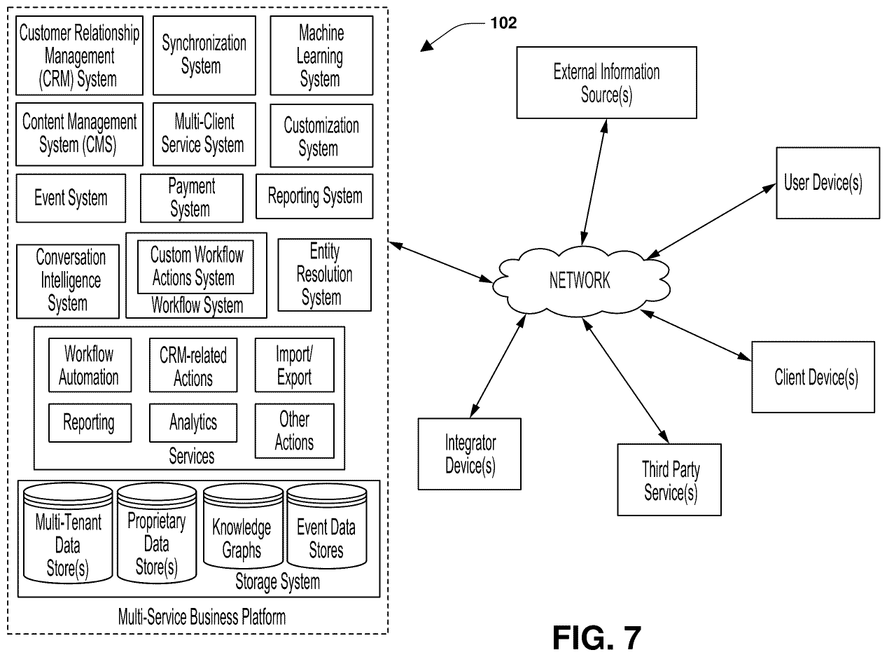

FIG. 1 is a block diagram illustrating an embodiment of a system 100 for hierarchical topic generation using large language models. A multi-service business platform 102 may include a topic generator 108 configured to perform the hierarchical topic generation. In some embodiments, the topic generator 108 may be hosted as part of a framework implemented for hierarchical topic generation. It may be appreciated that additional details of the multi-service business platform 102 will be subsequently described in relation to FIG. 7. For example, the topic generator 108 may be implemented as part of the systems and services illustrated by FIG. 7. The topic generator 108 may process content from external information sources remote to the multi-service business platform 102 and/or from a storage system of the multi-service business platform 102 that may include multi-tenant data stores, proprietary data stores, knowledge graphs, and/or event data stores. The topic generator 108 may output analysis results that may interact with the various systems and/or services of the multi-service business platform 102, such as a customer relationship management (CRM) system, a synchronization system, a machine learning system hosting or providing access to large language models (LLMs) 106 used by the topic generator 108, a content management system (CMS), a multi-client service system, a customization system, an event system, a payment system, a reporting system, a conversation intelligence system, a custom workflow actions system, a workflow system, an entity resolution system, services (e.g., workflow automation, reporting, CRM-related actions, analytics, import/export, and other actions), etc.

The multi-service business platform 102 may host or provide access to a corpus of content 104 extracted from data sources, such as from the storage system and/or the external information sources illustrated by FIG. 7. The content may include text, surveys, call transcripts, emails, support tickets, website content, text extracted from objects of a CRM database, images, videos, a blog, a social media post, and/or any other type of content. The topic generator 108 may implement a workflow that includes a series of prompts that are input into large language models 106 for generating initial topics (macro topics) for the content within the corpus of content 104. The initial topics may be macro-level topics for the content, such as topics assigned to documents of the corpus of content 104. The topic generator 108 may iteratively merge and/or remove overlapping topics of the initial topics to create a refined set of topics. The overlapping topics may be identified using the LLMs 106 that are capable of identifying overlapping topics where two topics are semantically similar, but linguistically different (e.g., two surveys discussing the same topic of exercise, but one talks about a marathon training diet and the other talks about post-race recovery).

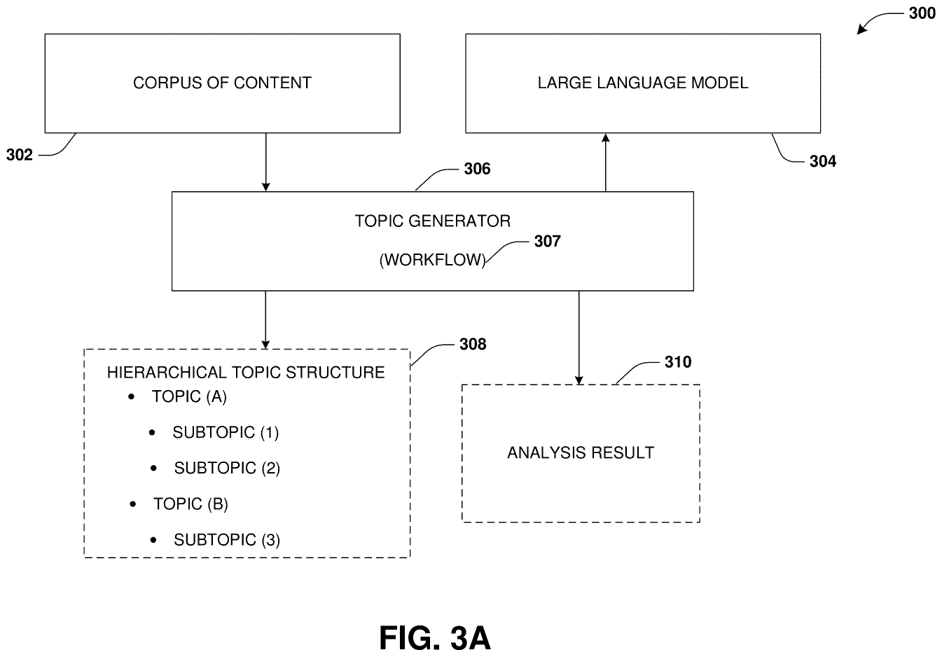

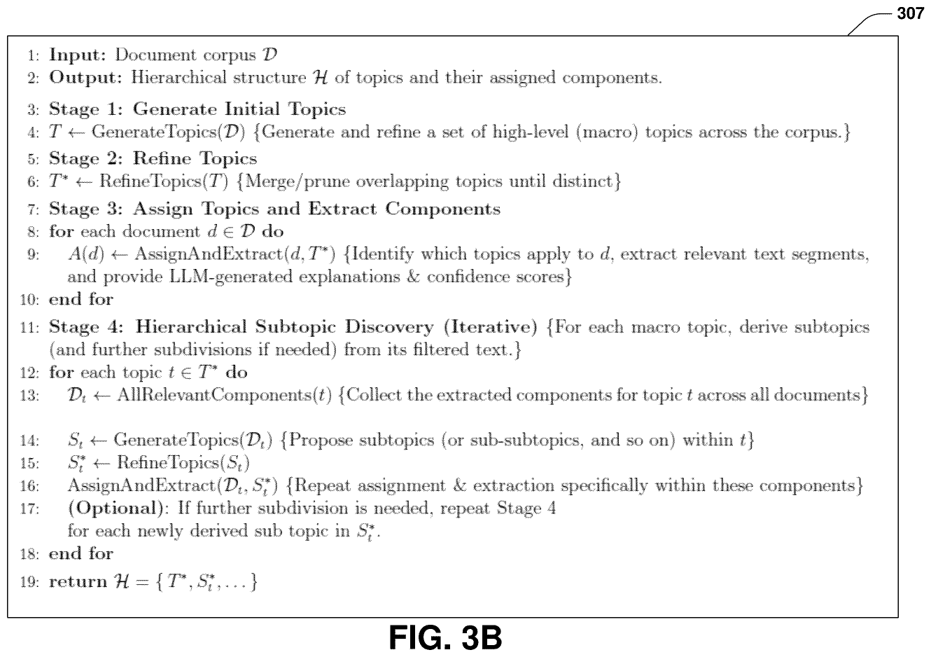

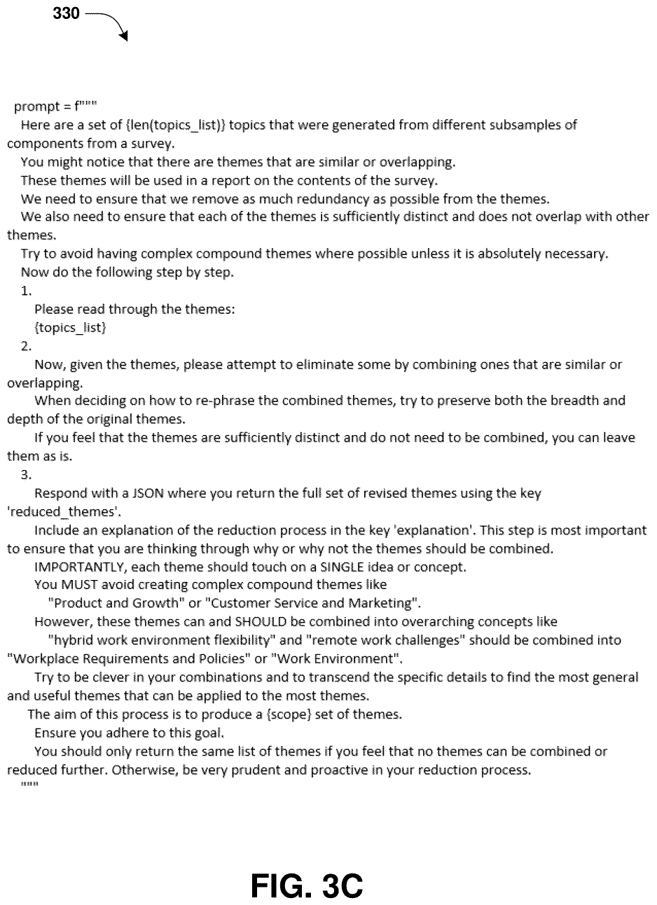

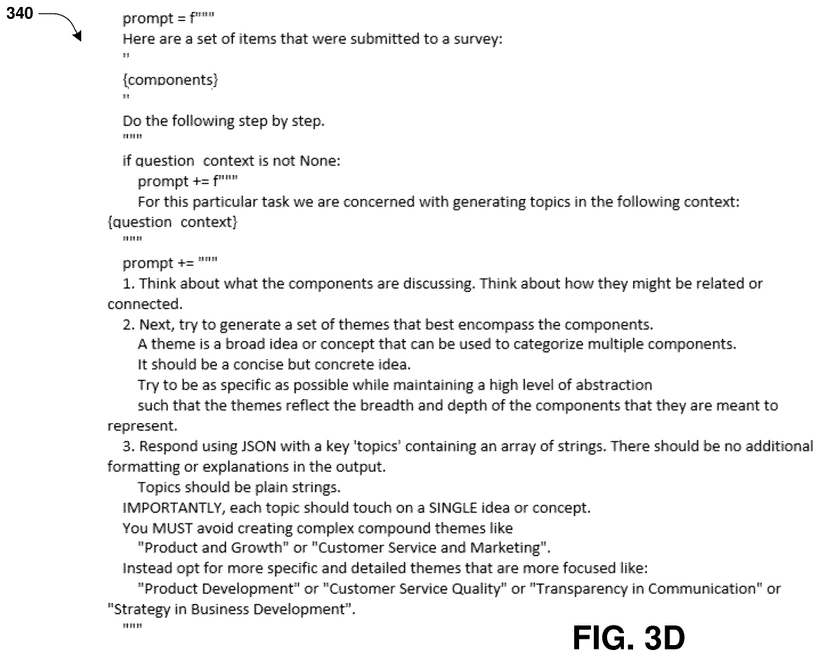

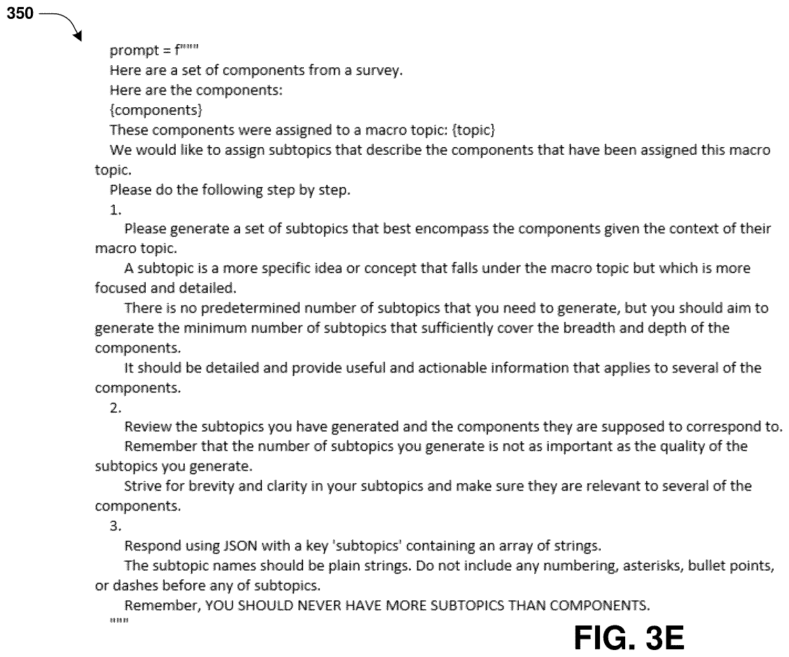

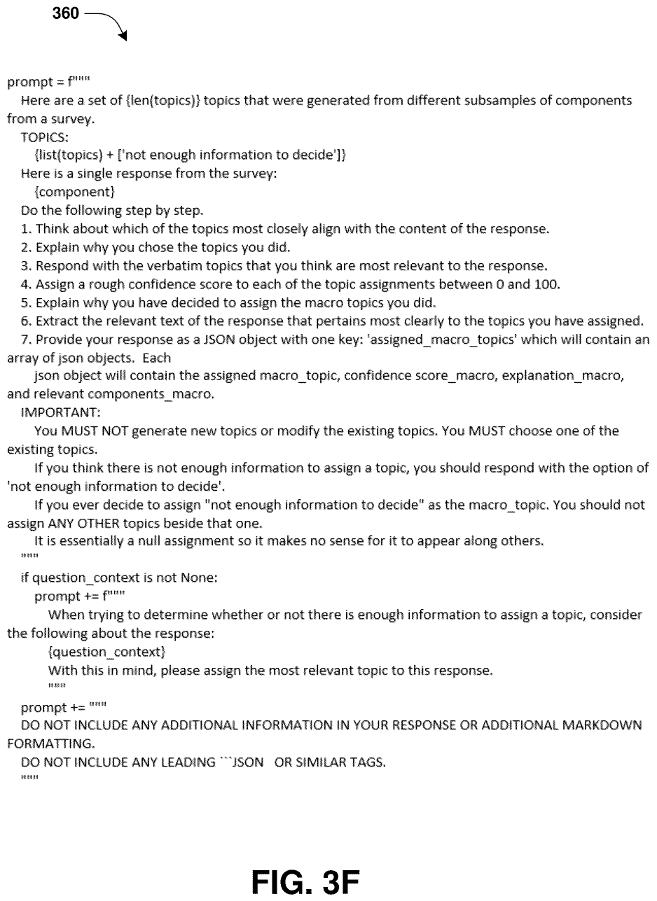

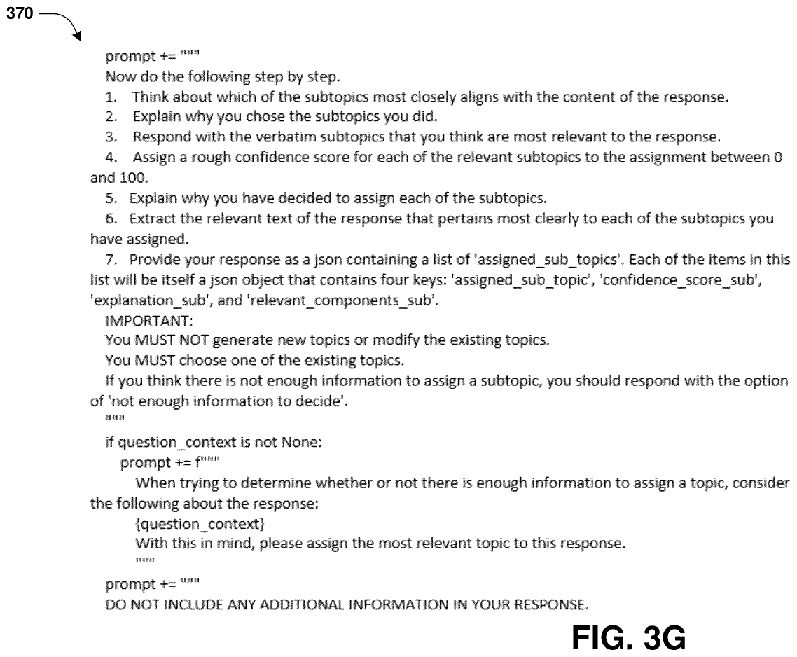

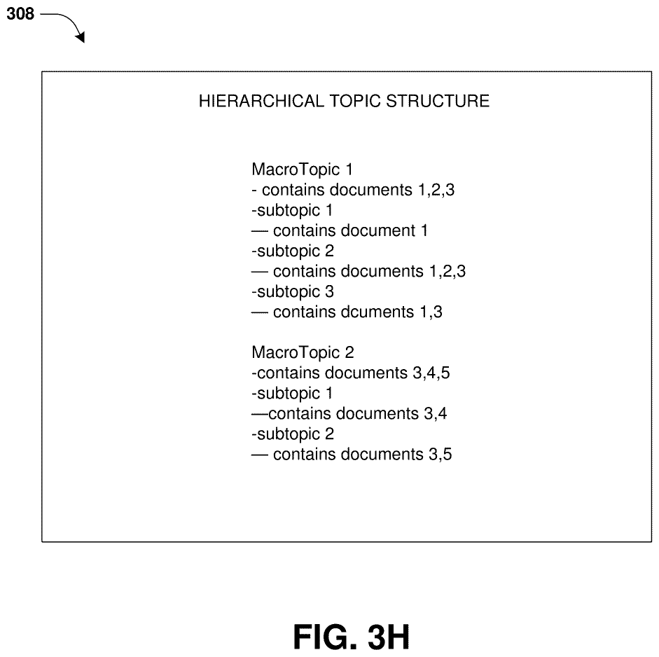

In some embodiments, a prompt is generated and input into the LLMs 106 for merging or removing overlapping topics in a manner where each remaining topic touches on a single idea or concept. The prompt may instruct the LLMs 106 to avoid creating complex compound themes. In an example, the prompt may instruct the LLMs 106 to “transcend the specific details to find the most general and useful themes that can be applied to the most themes.” In some embodiment, as illustrated by prompt 330 of FIG. 3C, the prompt may be defined as:

Prompt=f“““Here are a set of {len(topics_list)} topics that were generated from different subsamples of components from a survey. You might notice that there are themes that are similar or overlapping. These themes will be used in a report on the contents of the survey. We need to ensure that we remove as much redundancy as possible from the themes. We also need to ensure that each of the themes is sufficiently distinct and does not overlap with other themes. Try to avoid having complex compound themes where possible unless it is absolutely necessary. Now do the following step by step. 1. Please read through the themes: {topics_list}. 2. Now, given the themes, please attempt to eliminate some by combining ones that are similar or overlapping. When deciding on how to re-phrase the combined themes, try to preserve both the breadth and depth of the original themes. If you feel that the themes are sufficiently distinct and do not need to be combined, you can leave them as is. 3. Respond with a JSON where you return the full set of revised themes using the key ‘reduced_themes’. Include an explanation of the reduction process in the key ‘explanation’. This step is most important to ensure that you are thinking through why or why not the themes should be combined. IMPORTANTLY, each theme should touch on a SINGLE idea or concept. You MUST avoid creating complex compound themes like “Product and Growth” or “Customer Service and Marketing”. However, these themes can and SHOULD be combined into overarching concepts like “hybrid work environment flexibility” and “remote work challenges” should be combined into “Workplace Requirements and Policies” or “Work Environment”. Try to be clever in your combinations and to transcend the specific details to find the most general and useful themes that can be applied to the most themes. The aim of this process is to produce a {scope} set of themes. Ensure you adhere to this goal. You should only return the same list of themes if you feel that no themes can be combined or reduced further. Otherwise, be very prudent and proactive in your reduction process.”””

The topic generator 108 invokes the LLMs 106 to iteratively assign subtopics to the content. A topic is used as an anchor to provide contextual awareness for subtopic generation so that subtopics derived from the topic are contextually related to the topic (e.g., an exercise topic may be used as an anchor so that a marathon training diet subtopic, but not a dining out subtopic, are eligible as subtopics). Subtopics may be identified for a subtopic, and so forth. In this way, the topic generator 108 creates a hierarchical topic structure 110 of topics and subtopics. The hierarchical topic structure 110 may be used to generate and/or perform various analysis results/actions.

In some embodiments of generating and performing the analysis results/actions, the framework automatically tracks and evolves features of a website/application based on user preferences that the framework learns as the user utilizes the framework. In some embodiments, the framework utilizes a time dimension, and tracks how topics emerge, merge, split, and evolve over time. The framework could identify emerging trends and predict future topic developments based on historical patterns. In some embodiments, the framework analyzes images, video transcripts, and/or audio content simultaneously to create unified topic hierarchies that bridge different types of media while maintaining context of a topic with which different content items are associated. In some embodiments, the framework uses the hierarchical topic structure 110 to improve search relevance by understanding context at multiple levels (e.g., macro topics, subtopics, subtopics of the subtopics, etc.). The framework enables “topic-aware” search that will intelligently incorporate information from surrounding/related topics. In some embodiments, the framework generates other related topics that appear to be missing in the corpus of content 104. The topics, specified by the hierarchical topic structure 110, could be used as an angle/consideration for further understanding the content within the corpus of content 104. The framework not only identifies existing topics, but generates potential missing topics. The framework predicts theoretical topics that should exist based on pattern analysis. The framework could identify knowledge gaps or unexplored conceptual areas.

In some embodiments of generating and performing the analysis results/actions, the framework provides for topic relations by investigating links between seemingly unrelated topics. The framework identifies hidden correlations across vast semantic distances.

In some embodiments, the framework analyzes company surveys, such as engineering infrastructure surveys, systems usability surveys, and employee net promotor score surveys to identify topics. In some embodiments, the framework analyzes call transcripts, emails, support tickets, and/or other data streams. In some embodiments, the framework analyzes information related to content associated with a customer for describing and understanding the customer's journey (e.g., a journey of the customer interacting with content of a business, such as a website, blog, email, sales call, etc.). The framework may analyze such data to identify factors that lead to customers cancelling (e.g., price, product/service issues, etc.).

In some embodiments, the framework may utilize the analysis results/actions to enhance a customer relations management (CRM) system, a content management system, marketing hub applications, service hub implementation, and/or sales hub integration. The framework may provide for contact intelligence. In particular, the framework analyzes customer communications (e.g., emails, chat logs, call transcripts, etc.) to identify key topics and concerns. The framework may create hierarchical topic maps of customer interactions to understand relationship evolution and evolution of needs over time (e.g., over time, customers may interact with different content items having different topics). The framework generates dynamic contact profiles based on identified topics of interest (e.g., a contact profile object may be created within a CRM database for a user, and may be populated with topics of content associated with the user). The framework predicts future customer needs based on topic patterns (e.g., the user has started interacting with content having topic related to data storage, and thus the user may have a data storage need). In some embodiments, the framework provides for smart content organization by automatically categorizing and tagging blog posts, website content, or other content with topics that may be used to group such content may similar topics. The framework creates dynamic content hierarchies based on topic relationships, and suggests content gaps based on generative topic inference (e.g., a running shoe topic may be inferred for topics related to marathon training). The framework enables semantic search across a content library (e.g., a query having a certain topic may be used to identify content having semantic similarity to the topic). The framework may provide for content performance analytics, and tracks topic performance over time. The framework identifies trending topics and predicts future content opportunities. The framework maps content journey paths based on topic relationships (e.g., a user consuming various content items having topics that have some sort of topic relationships).

In some embodiments, the framework provides for campaign intelligence by analyzing campaign performance through a topic-based lens to identify the most engaging topics across different audience segments for generating topic-based content recommendations. The framework maps competitor content topics to identify opportunities (e.g., if a competitor website and documentation relates to a new cloud storage system, then a cloud storage system topic may be identified as an opportunity to provide users with cloud storage). In some embodiments, the framework provides for email marketing enhancement by generating dynamic email content based on recipient's topic interests (e.g., including text, images, or other email content related to topics that are identified as being relevant to a recipient). The framework provides for subject line optimization using topic performance data such as by generating subject lines for emails (e.g., including text related to topics that are identified as being relevant to a recipient). The framework generates personalized content journeys based on topic engagement (e.g., the framework generates videos, images, descriptions, website content, emails, blogs, or other content that is tailored to topics of interest for a particular user).

In some embodiments, the framework provides for survey analysis where users can utilize the framework to analyze surveys the users conducted to gain valuable insights from text data. The framework may provide for knowledge base optimizations, such as to organize support documentation using hierarchical topic modeling. The framework identifies knowledge gaps using generative topic inference. The framework creates dynamic FAQ structures based on customer queries, and enables context-aware search across support materials. In some embodiments, the framework may provide for ticket analysis (e.g., customer service/troubleshooting tickets), and categorizes support tickets using multi-topic assignment. The framework tracks emerging support issues through temporal topic evolution. The framework generates topic-based routing rules for support teams. In some embodiments, the framework analyzes sales calls to generate topic-based sales insights tailored to individual customers. The framework creates dynamic sales playbooks based on successful topic patterns. The framework predicts deal outcomes based on topic coverage. In this way, the hierarchical topic structure 110 is used to generate and/or perform various analysis results/actions.

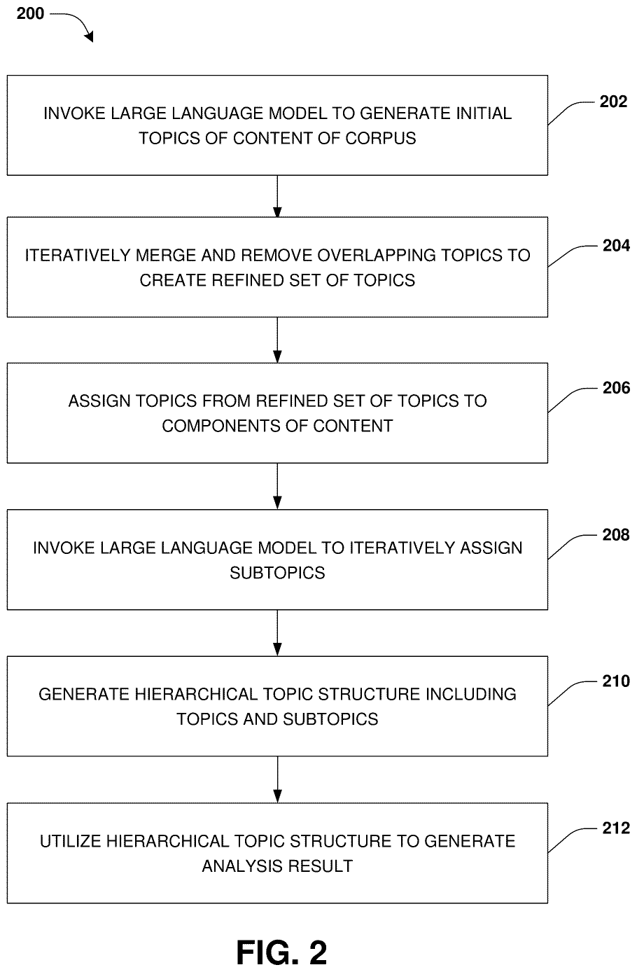

FIG. 2 is a flow chart illustrating an embodiment of a method 200 for hierarchical topic generation using large language models, which is described in conjunction with system 300 FIG. 3A. A topic generator 306 may be configured to execute the method 200. In some embodiments, the topic generator 306 may part of a platform implemented by the multi-service business platform 102 for generating hierarchical topic structures used to generate and perform analysis results/actions. The topic generator 306 may implement a workflow 307 that includes a series of prompts used to control a large language model (LLM) 304 for generating a hierarchical topic structure 308. It may be appreciated that an embodiment of the workflow 307 is illustrated by FIG. 3B, which includes the following steps:
1: Input: Document corpus D
2: Output: Hierarchical structure H of topics and their assigned components.
3: Stage 1: Generate Initial Topics
4: T←GenerateTopics(D) {Generate and refine a set of high-level (macro) topics across the corpus.}
5: Stage 2: Refine Topics
6: T*←RefineTopics(T) {Merge/prune overlapping topics until distinct}
7: Stage 3: Assign Topics and Extract Components
8: for each document d∈D do
9: A(d)←AssignAndExtract(d, T*) {Identify which topics apply to d, extract relevant text segments, and provide LLM-generated explanations & confidence scores}
10: end for
11: Stage 4: Hierarchical Subtopic Discovery (Iterative) {For each macro topic, derive subtopics (and further subdivisions if needed) from its filtered text.}
12: for each topic t∈T* do
13: Dt ←AllRelevantComponents(t) {Collect the extracted components for topic t across all documents}
14: St←GenerateTopics(Dt) {Propose subtopics (or sub-subtopics, and so on) within t}
15: S*t←RefineTopics(St)
16: AssignAndExtract(Dt, S*t) {Repeat assignment & extraction specifically within these components}
17: (Optional): If further subdivision is needed, repeat Stage 4 for each newly derived sub topic in S*t
18: end for
19: return H={T*, S*t, . . . }.

In some embodiments, as illustrated by prompt 340 of FIG. 3D, a prompt for topic generation may be defined as: prompt=f“““Here are a set of items that were submitted to a survey: “{components}” Do the following step by step. “““if question_context is not None: prompt+=f””” For this particular task we are concerned with generating topics in the following context: {question_context} “““prompt+=””38 1. Think about what the components are discussing. Think about how they might be related or connected. 2. Next, try to generate a set of themes that best encompass the components. A theme is a broad idea or concept that can be used to categorize multiple components. It should be a concise but concrete idea. Try to be as specific as possible while maintaining a high level of abstraction such that the themes reflect the breadth and depth of the components that they are meant to represent. 3. Respond using JSON with a key ‘topics’ containing an array of strings. There should be no additional formatting or explanations in the output. Topics should be plain strings. IMPORTANTLY, each topic should touch on a SINGLE idea or concept. You MUST avoid creating complex compound themes like “Product and Growth” or “Customer Service and Marketing”. Instead opt for more specific and detailed themes that are more focused like: “Product Development” or “Customer Service Quality” or “Transparency in Communication” or “Strategy in Business Development”.”””

In some embodiments, as illustrated by prompt 350 of FIG. 3E, a prompt for subtopic generation may be defined as: prompt =f“““Here are a set of components from a survey. Here are the components: {components}. These components were assigned to a macro topic: {topic}. We would like to assign subtopics that describe the components that have been assigned this macro topic. Please do the following step by step. 1. Please generate a set of subtopics that best encompass the components given the context of their macro topic. A subtopic is a more specific idea or concept that falls under the macro topic but which is more focused and detailed. There is no predetermined number of subtopics that you need to generate, but you should aim to generate the minimum number of subtopics that sufficiently cover the breadth and depth of the components. It should be detailed and provide useful and actionable information that applies to several of the components. 2. Review the subtopics you have generated and the components they are supposed to correspond to. Remember that the number of subtopics you generate is not as important as the quality of the subtopics you generate. Strive for brevity and clarity in your subtopics and make sure they are relevant to several of the components. 3. Respond using JSON with a key ‘subtopics’ containing an array of strings. The subtopic names should be plain strings. Do not include any numbering, asterisks, bullet points, or dashes before any of subtopics. Remember, YOU SHOULD NEVER HAVE MORE SUBTOPICS THAN COMPONENTS.”””

In some embodiments, as illustrated by prompt 360 of FIG. 3F, a prompt for topic assignment may be defined as: prompt=f“““Here are a set of {len(topics)} topics that were generated from different subsamples of components from a survey. TOPICS: {list(topics)+[‘not enough information to decide’]}. Here is a single response from the survey: {component} Do the following step by step. 1. Think about which of the topics most closely align with the content of the response. 2. Explain why you chose the topics you did. 3. Respond with the verbatim topics that you think are most relevant to the response. 4. Assign a rough confidence score to each of the topic assignments between 0 and 100. 5. Explain why you have decided to assign the macro topics you did. 6. Extract the relevant text of the response that pertains most clearly to the topics you have assigned. 7. Provide your response as a JSON object with one key: ‘assigned_macro_topics’ which will contain an array of json objects. Each json object will contain the assigned macro_topic, confidence score_macro, explanation_macro, and relevant components_macro. IMPORTANT: You MUST NOT generate new topics or modify the existing topics. You MUST choose one of the existing topics. If you think there is not enough information to assign a topic, you should respond with the option of ‘not enough information to decide’. If you ever decide to assign ”not enough information to decide” as the macro_topic. You should not assign ANY OTHER topics beside that one. It is essentially a null assignment so it makes no sense for it to appear along others. “““If question_context is not None: prompt+=f”””When trying to determine whether or not there is enough information to assign a topic, consider the following about the response: {question_context}. With this in mind, please assign the most relevant topic to this response. “““Prompt+=”””DO NOT INCLUDE ANY ADDITIONAL INFORMATION IN YOUR RESPONSE OR ADDITIONAL MARKDOWN FORMATTING. DO NOT INCLUDE ANY LEADING ′′′JSON OR SIMILAR TAGS.”””

In some embodiments, as illustrated by prompt 370 of FIG. 3G, a prompt for multi-subtopic assignment may be defined as: prompt+=“““Now do the following step by step. 1. Think about which of the subtopics most closely aligns with the content of the response. 2. Explain why you chose the subtopics you did. 3. Respond with the verbatim subtopics that you think are most relevant to the response. 4. Assign a rough confidence score for each of the relevant subtopics to the assignment between 0 and 100. 5. Explain why you have decided to assign each of the subtopics. 6. Extract the relevant text of the response that pertains most clearly to each of the subtopics you have assigned. 7. Provide your response as a json containing a list of ‘assigned_sub_topics’. Each of the items in this list will be itself a json object that contains four keys: ‘assigned_sub_topic’, ‘confidence_score_sub’, ‘explanation_sub’, and ‘relevant_components_sub’. IMPORTANT: You MUST NOT generate new topics or modify the existing topics. You MUST choose one of the existing topics. If you think there is not enough information to assign a subtopic, you should respond with the option of ‘not enough information to decide’.””” if question_context is not None: prompt+=f“““When trying to determine whether or not there is enough information to assign a topic, consider the following about the response: {question_context}. With this in mind, please assign the most relevant topic to this response.””” Prompt+=“““DO NOT INCLUDE ANY ADDITIONAL INFORMATION IN YOUR RESPONSE.”””

During operation 202 of method 200, the topic generator 306 implements the workflow 307 to generate prompts used to control the LLM 304 to generate initial topics (macro topics) for content within a corpus of content 302. In some embodiments, business context information is input into the LLM 304 for generating topics and subtopics relevant to a business. In some embodiments, the corpus of content 302 includes employee surveys, and the topic generator 306 executes the workflow 307 to identify topics associated with the employee surveys. In some embodiments, the corpus of content 302 includes call transcripts, emails, support tickets, and/or other information, and the topic generator 306 executes the workflow 307 to identify topics associated with the call transcripts, emails, support tickets, and/or other information. It may be appreciated that the topic generator 306 may identify topics associated with any type of content, such as text, images, videos, audio, etc.

During operation 204 of method 200, the topic generator 306 executes the workflow 307 to generate prompts used to iteratively merge and remove overlapping topics of the initial topics to create a refined set of topics. In some embodiments, a first initial topic and a second initial topic may be identified as overlapping based upon the first initial topic and the second initial topic having a semantic similarity above a first threshold (e.g., a high semantic similarity) and a linguistic difference above a second threshold (e.g., a high linguistic difference where words/language differ across the two initial topics). Accordingly, one of the initial topics is removed from the initial topics, or the two initial topics are merged to create a single distinct topic for inclusion within the refined set of topics.

During operation 206 of method 200, the topic generator 306 executes the workflow 307 to generate prompts used to assign topics from the refined set of topics to components of the content (e.g., words, paragraphs, etc.). Multiple topics may be assigned to a single document such as where a first topic is assigned to a first component and a second topic is assigned to a second component. In some embodiments, multiple topics are assigned to a component. In some embodiments, text contents of a component may be shared by multiple topics. In some embodiments, content may include the component “I never feel like I get to sleep enough after holidays and it's really affecting my productivity.” Each clause of the component depends on the other clauses. For topics such as “productivity,” “holidays,” and “burnout,” the framework would assign all 3 topics to this sentence (to this single component), and then the relevant components would overlap between the different topics. This co-incidental topic assignment on a component gives the user an instant ability to see how topics relate and depend on each other.

During operation 208 of method 200, the topic generator 306 executes the workflow 307 to generate prompts used to control the LLM 304 to iteratively assign subtopics to the content. A topic may be used as an anchor that provides contextual awareness for subtopic generation. That is, the subtopic generation may be constrained by the anchor to consider/generate subtopics that are related to the topic (e.g., a marathon training diets subtopic may be semantically related to an exercise topic, but a restaurant subtopic may not be semantically related to the exercise topic). Potential subtopics for a component may be restricted to subtopics identified as being relevant/similar to a parent topic for which the subtopics are being anchored and derived. In this way, context-aware subtopic generation is performed where parent topics are used as context for generating a subtopic. In some embodiments, subtopics may be created for subtopics, and so forth where a subtopic is subdivided into one or more subtopics.

In some embodiments, components of the corpus of content 302 may be segmented by assigned topic, and subtopics are generated within a particular subset of components. In some embodiments, subtopic generation is constrained to components that have been explicitly connected to a specific theme (a topic such as a macro-topic), and thus subtopic generation reveals the intricacies and details of what is contained within a theme in a dynamic and iterative manner.

In some embodiments of subtopic generation, the topic generator 306 parses text of a component to which a topic is assigned (e.g., parses text of a document to which a topic (A) is assigned). The topic generator 306 evaluates the text using the LLM 304 to generate a subtopic such as subtopic (1) and subtopic (2) that are contextually related to the topic (A).

In some embodiments of subtopic generation, the topic generator 306 extracts components for which a topic is assigned across the corpus of content 302. The topic generator 306 utilizes the LLM 304 to generate proposed subtopics from the components. The proposed subtopics may be refined to generate refined subtopics (e.g., overlapping subtopics may be merged or removed). The proposed subtopics and/or the refined subtopics may be used to assign topics for the components.

In some embodiments, iterative refinement of the topics and subtopics may be performed using semantic reduction to select certain topics/subtopics for inclusion within the hierarchical topic structure 308. Semantic reduction is an iterative prompting process where an LLM is asked to combine related concepts while ensuring that sufficient breadth and depth are retained. Reliably doing this reduction and balancing would be intractable for any non LLM-based algorithms for topic reduction or refinement would be unable to reliably do this reduction and balancing.

During operation 210 of method 200, the hierarchical topic structure 308 is created to include the selected topics and subtopics. In some embodiments, the hierarchical topic structure 308 is implemented as a data structure where subtopics are nested below parent topics from which the subtopics are derived. For example, a first level (a top level) may include a node representing a macro-topic, a second level (a next level down) may include nodes representing subtopics of that macro-topic, a third level (a next level down from the second level) may include nodes representing subtopics of a subtopic in the second level, etc. The hierarchical topic structure 308 may include any number of levels of nested topics/subtopics. In some embodiments, topics that apply to text segments of a document are identified by the topic generator 306. The topic generator 306 extracts the text segments, and inputs the text segments into the LLM 304 for generating explanations and confidence scores for the topics. In some embodiments, the topic generator 306 utilizes large language model chain-of-thought reasoning to generate an explanatory justification for topic assignments within the hierarchical topic structure 308. In this way, the hierarchical topic structure 308 is generated, and reasons/justifications for the topic assignments within the hierarchical topic structure 308 are created. FIG. 3H illustrates an embodiment of the hierarchical topic structure 308 where subtopics are defined only within (constrained to) the context of a macro topic (parent topic). In some embodiments, the components from document 3 are assigned multiple topics and subtopics, which indicates a richness of document 3 in how many distinct ideas are referenced by document 3.

During operation 212 of method 200, the hierarchical topic structure 308 is utilized to generate and/or execute an analysis result 310 (an analysis action). In some embodiments, the hierarchical topic structure 308 is used to identify information associated with customer journeys of experiencing content related to business. The information may relate to topics of content (e.g., a topic of a webpage, blog, article, email, etc.) that a customer or potential customer consumes along a customer journey (e.g., a journey of consuming content of a business, leading up to the customer purchasing a product or service). The information may be processed to identify factors leading to cancellation with the business (e.g., topics identified from customer complaint emails, customer reviews, call transcripts, support tickets, chats with chatbots, etc.).

In some embodiments, the hierarchical topic structure 308 is used to identify topics associated with call transcripts, emails, support tickets, and/or other types of content stored within the corpus of content 302. The hierarchical topic structure 308 is used to generate a hierarchical topic map of customer interactions for analyzing customer relationships and customer needs. For example, the hierarchical topic map may include representations of customers, products, services, topics, and/or other information, along with relationships between such information. The information and relationships may be evaluated to identify the customer relationships and needs (e.g., a customer is associated with a topic related to a feature being requested by the customer or a requested solution for an issue). The hierarchical topic map is used to generate dynamic contact profiles within a CRM database based upon the topics and the hierarchical topic map. A contact object may be created for a customer, and populated with the topics and/or customer relationships and customer needs.

In some embodiments, the hierarchical topic structure 308 is used to automatically categorize and/or tag content hosted within the multi-service business platform. For example, a webpage, a blog article, an object within the CRM database, a chat transcript, a workflow, a service ticket, or any other content may be tagged or categorized with one or more topics. In some embodiments, the hierarchical topic structure 308 is used to track topic performance, identify trending topics, and/or predict future content opportunities of content to provider to users.

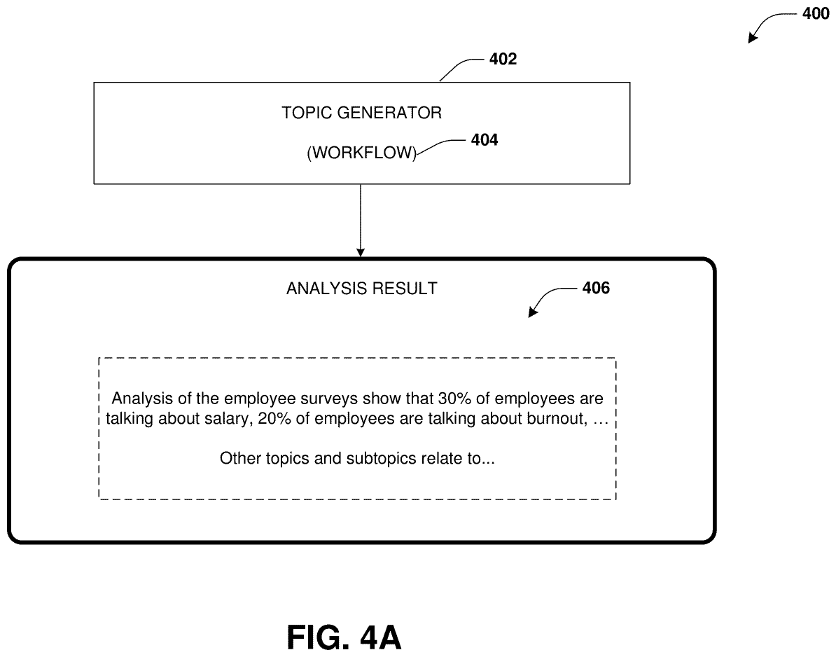

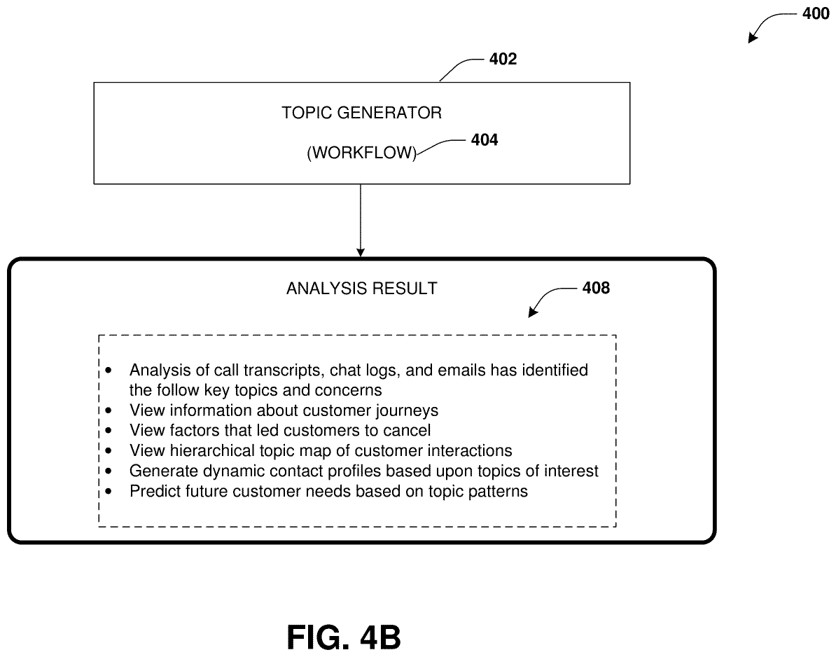

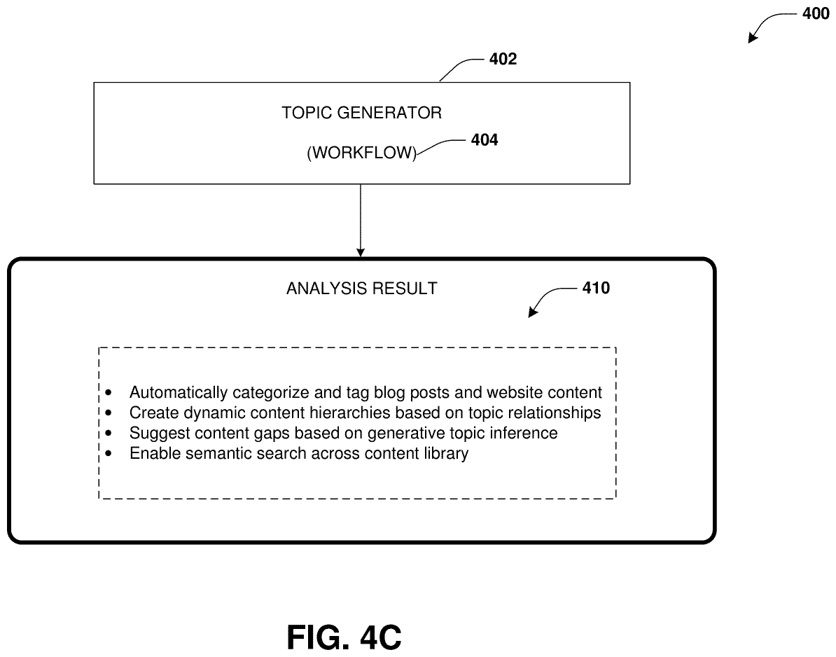

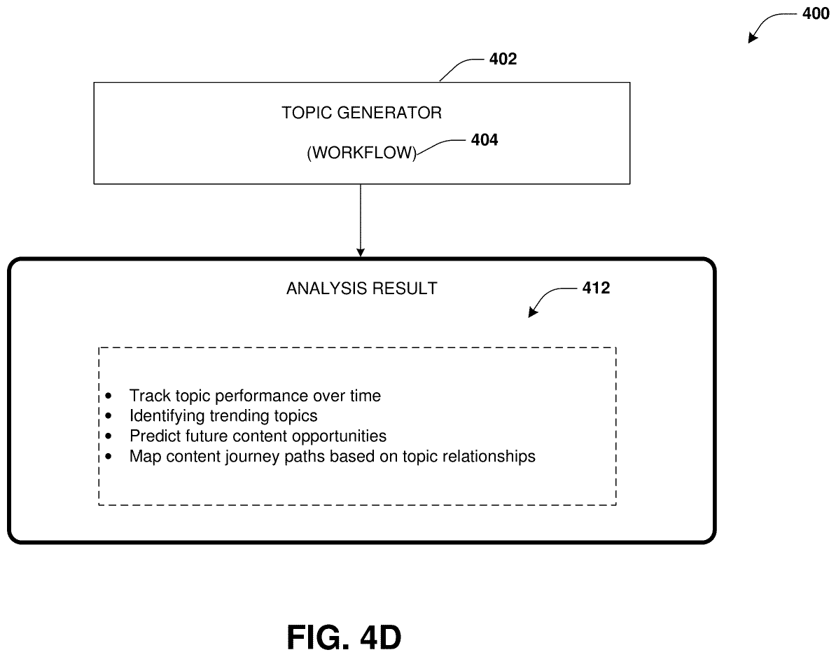

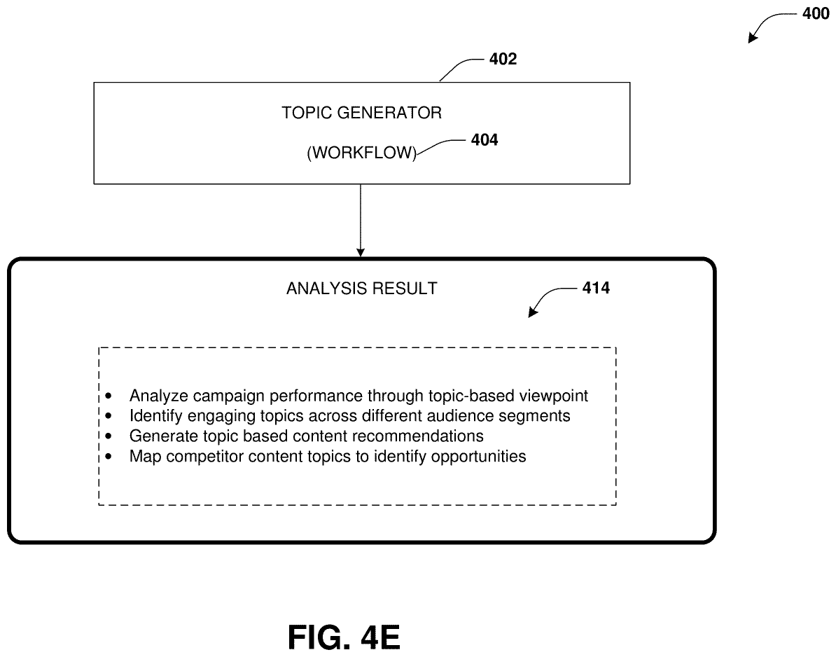

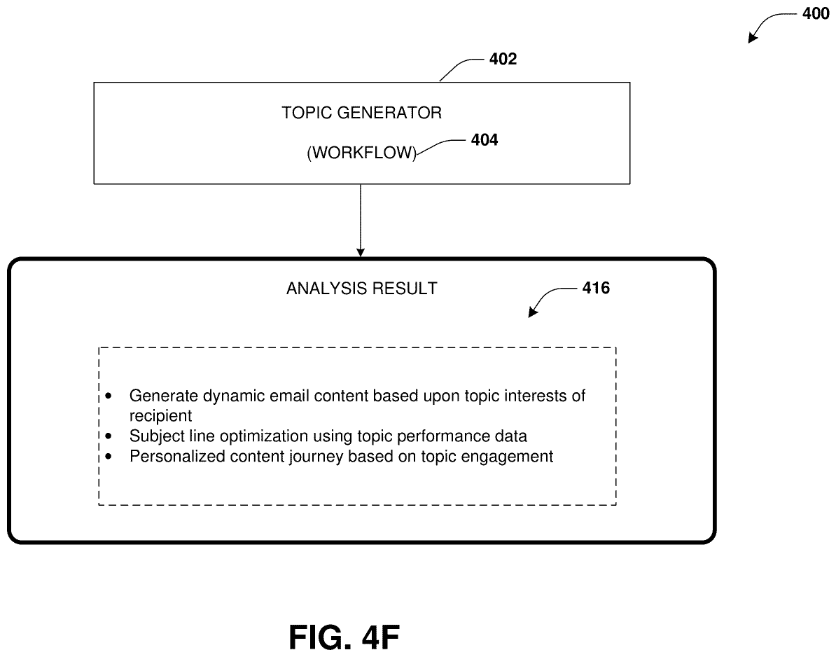

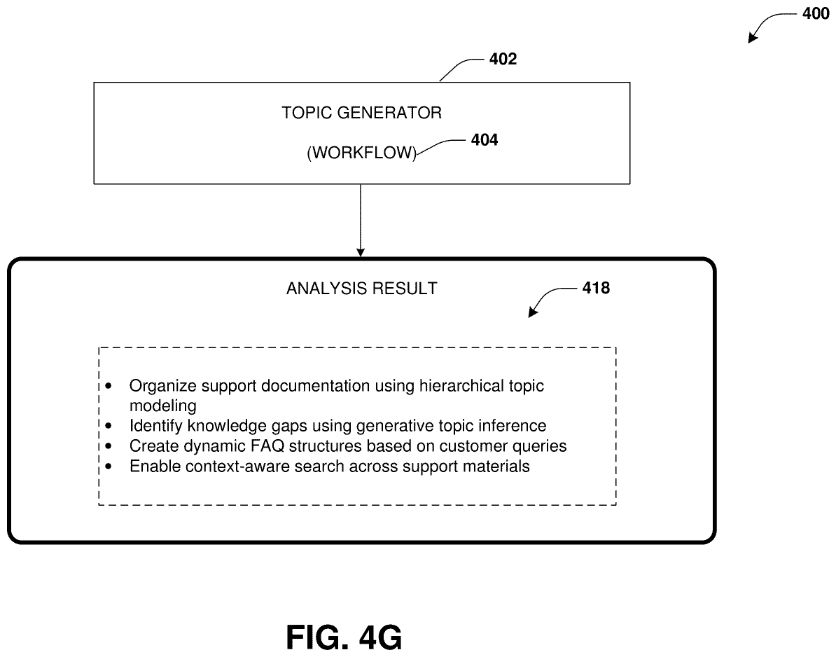

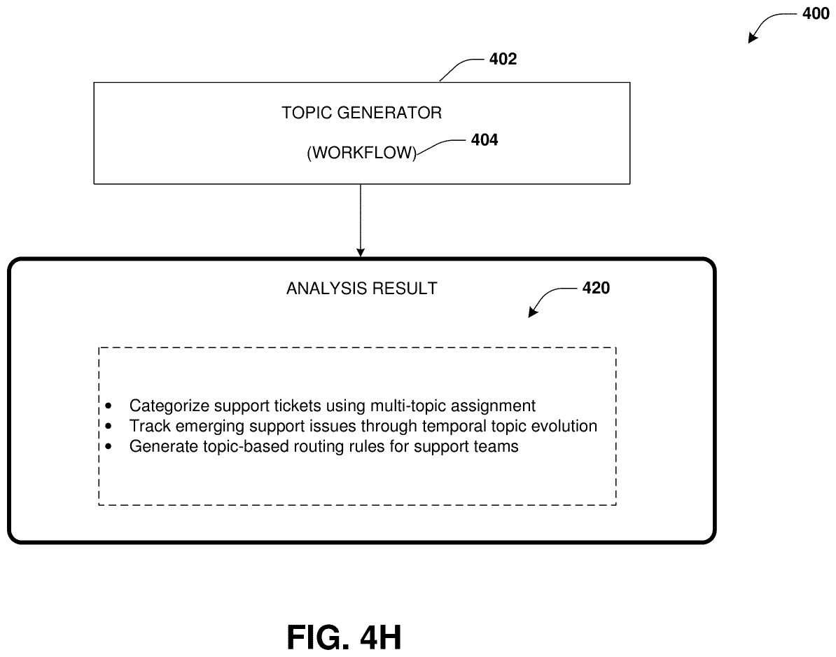

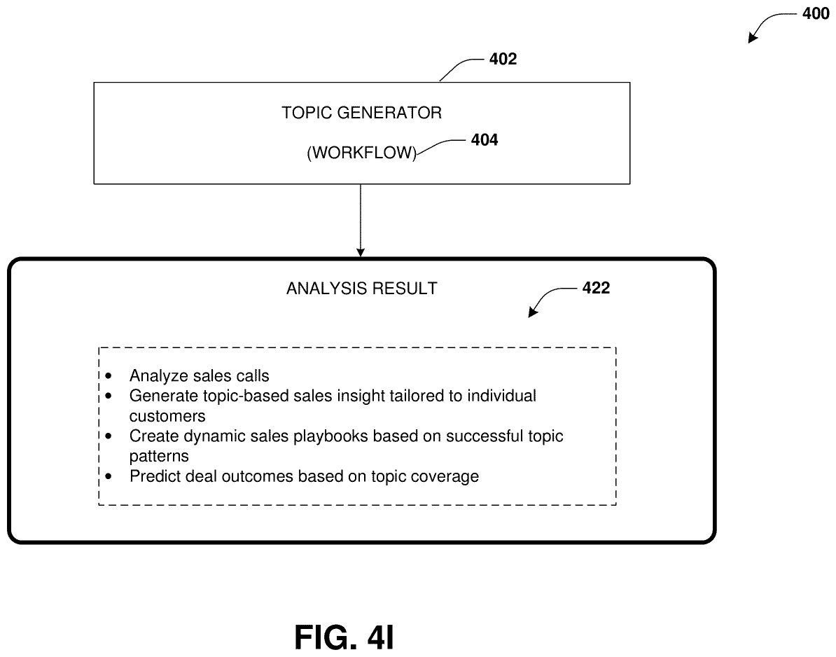

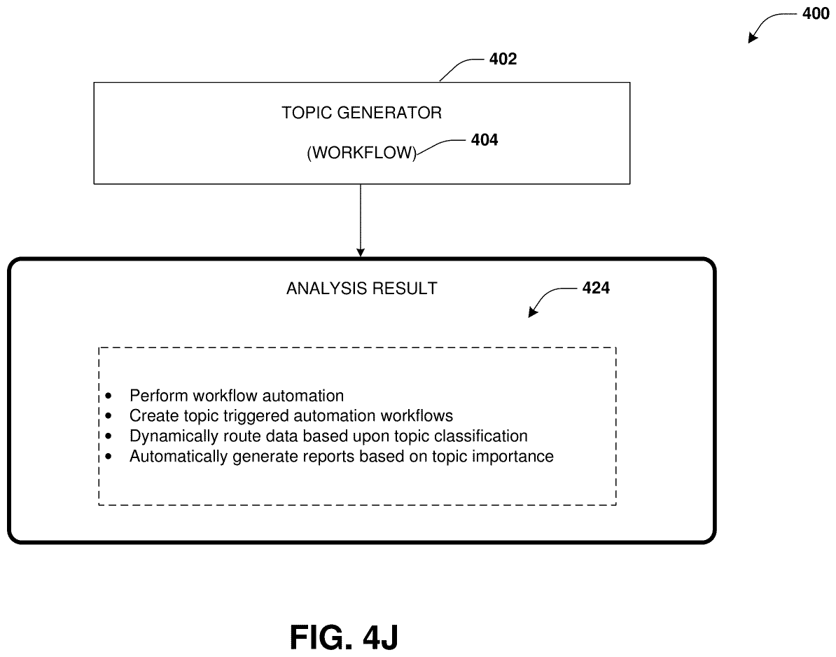

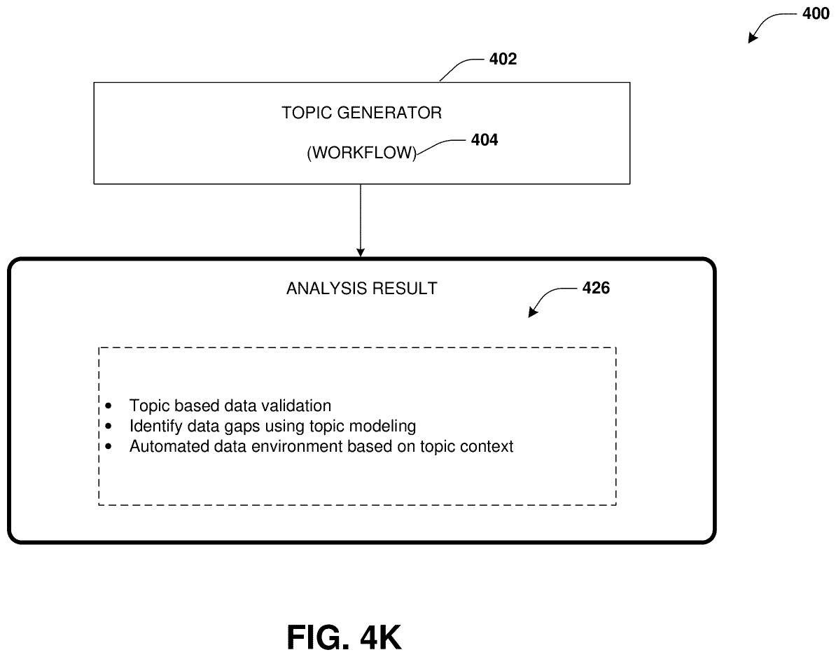

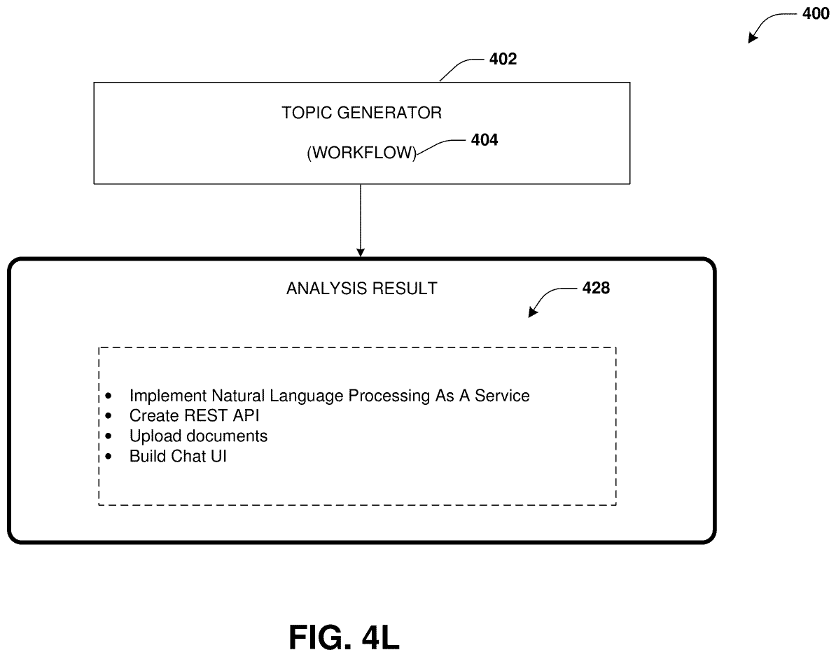

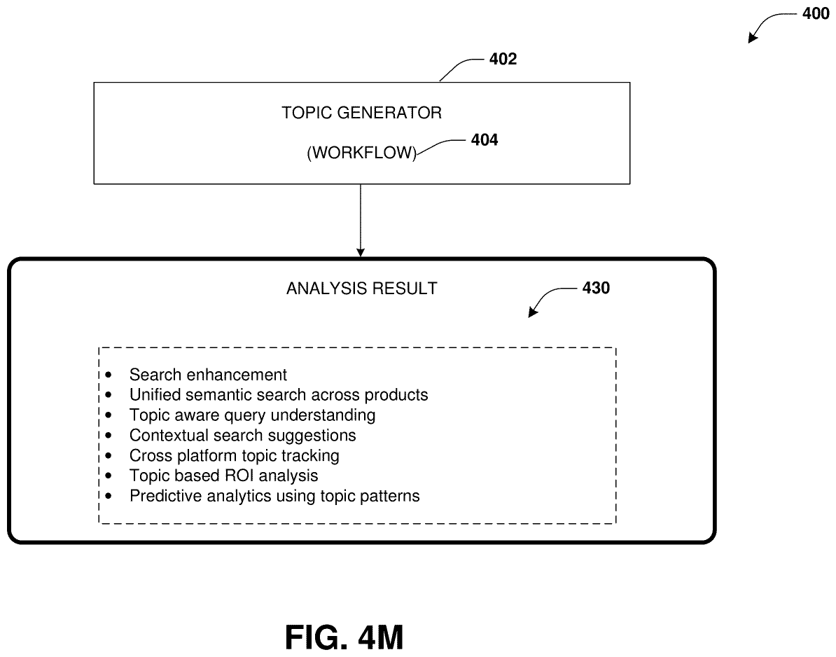

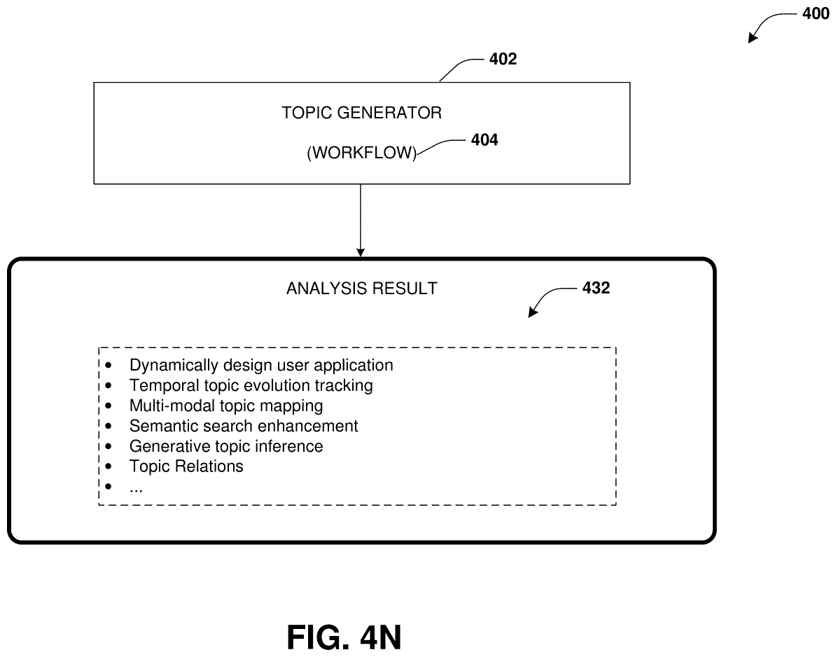

FIGS. 4A-4N illustrate a system 400 that includes a topic generator 402 configured to execute a workflow 404 for generating analysis results. FIG. 4A illustrates an analysis result 406 where employee surveys were analyzed by the topic generator 402 to identify topics discussed in the employee surveys and then the labeled results are used to make more effective and informed business decisions. FIG. 4B illustrates an analysis result 408 where call transcripts, chat logs, and emails were evaluated to identify key topics and concern. The analysis result 408 provides information related to customer journeys, factors that led customers to cancel, a hierarchical map of customer interactions, the ability to generate dynamic contact profiles, and/or predict customer needs based on topic patterns. FIG. 4C illustrates an analysis result 410 where blog posts and website content can be automatically categorized, dynamic content hierarchies can be created based on topic relationships, content gaps are suggested based on generative topic inferences, and semantic search is enabled across a content library. FIG. 4D illustrates an analysis result 412 where topic performance can be tracked over time, trending topics can be identified, future content opportunities can be predicted, and content journey paths can be mapped based on topic relationships. FIG. 4E illustrates an analysis result 414 where campaign performance is analyzed through a topic-based viewpoint, engaging topics can be identified across different audience segments, topic based content recommendations can be generated, and competitor content topics can be mapped to opportunities to recommend/sell products and services related to the topics.

FIG. 4F illustrates an analysis result 416 where dynamic email content is generated based upon topic interests of recipients for emails, subject line optimization may be performed using topic performance data, and personalized content journeys of content to provide users may be created based on topic engagement. FIG. 4G illustrates an analysis result 418 where support documentation can be organized using hierarchical topic modeling, knowledge gaps can be identified using generative topic inference, dynamic FAQ structures can be created based on customer queries, and context-aware search may be enabled across support materials. FIG. 4H illustrates an analysis result 420 where support tickets may be categorized using multi-topic assignments, emerging support issues may be tracked through temporal topic evolutions, and topic-based routing rules may be generated for routing support tickets to support teams. FIG. 4I illustrates an analysis result 422 where sales calls are analyzed, topic-based sales insight is generated and tailored to individual customers, dynamic sales playbooks are created based on successful topic patterns, and deal outcomes are predicted based on topic coverage.

FIG. 4J illustrates an analysis result 424 where workflow automation is implemented, topics are created to trigger workflow automation, data is dynamically routed to workflows or routed by workflows based upon topic classifications of the data, and reports are automatically generated based on topic importance. FIG. 4K illustrates an analysis result 426 where topic based data validation is performed, data gaps are identified using topic modeling, and an automated data environment is provided based on topic context. FIG. 4L illustrates an analysis result 428 where natural language processing is implemented as a service, REST APIs to the service are created, and a chat UI is built and provided to users for uploading documents though the REST API to the service. FIG. 4M illustrates an analysis result 430 that provides search enhancement, unified semantic search across products, topic aware query understanding, contextual search suggestions, cross platform topic tracking, topic based ROI analysis, and predictive analytics using topic patterns. FIG. 4N illustrates an analysis result 432 that provides dynamically designed user applications, temporal topic evolution tracking, multi-modal topic mappings, semantic search enhancement, generative topic inference, and/or topic relations. In this way, various analysis results/actions may be performed by the topic generator 402 using hierarchical topic structures.

In some embodiments, a method is provided. The method includes invoking a large language model to generate initial topics for contents of a corpus; iteratively merging and removing overlapping topics of the initial topics to create a refined set of topics; assigning topics from the refined set of topics to components of the contents, wherein a first topic is assigned to a first component of a content and a second topic is assigned to a second component of the content; invoking the large language model to iteratively assign subtopics to the content, wherein a topic is used as an anchor providing contextual awareness for subtopic generation; generating a hierarchical topic structure including the topics and subtopics; and utilizing the hierarchical topic structure to generate an analysis result.

In some embodiments, the method includes determining that a first initial topic and a second initial topic overlap based upon the first initial topic and the second initial topic having a semantic similarity above a first threshold and a linguistic difference above a second threshold, wherein the first initial topic is either removed from the initial topics or is merged into the second initial topic to create a distinct topic for inclusion within the hierarchical topic structure.

In some embodiments, the method includes executing a workflow with a series of prompts to control the large language model for generating the hierarchical topic structure.

In some embodiments, the method includes for a content: determining topics that apply to text segments of the content; extracting the text segments from the content; and generating, utilizing the large language model, explanations and confidence scores for the topics.

In some embodiments, the method includes generating, utilizing large language model chain-of-thought reasoning, an explanatory justification for topic assignments within the hierarchical topic structure.

In some embodiments, the method includes performing context-aware subtopic generation using parent topics as context for generating a subtopic.

In some embodiments, the method includes for the topic: parsing text of contents to which the topic is assigned; and evaluating the text, using the large language model, to generate a subtopic.

In some embodiments, the method includes for the topic: extracting components for which the topic is assigned across the corpus; generating, utilizing the large language model, proposed subtopics from the components; refining the proposed subtopics to generate refined subtopics; and utilizing the proposed subtopics and the refined subtopics to assign and extract topics for the components.

In some embodiments, the method includes identifying one or more subtopics subdivided from the subtopic.

In some embodiments, a computing device is provided. The computing device comprises a memory comprising machine executable code; and a processor coupled to the memory, the processor configured to execute the machine executable code to cause the processor to perform operations comprising: invoking a large language model to generate initial topics for contents of a corpus; iteratively merging and removing overlapping topics of the initial topics to create a refined set of topics; assigning topics from the refined set of topics to components of the contents, wherein a first topic is assigned to a first component of a content and a second topic is assigned to a second component of the content; invoking the large language model to iteratively assign subtopics to the content, wherein a topic is used as an anchor providing contextual awareness for subtopic generation; generating a hierarchical topic structure including the topics and subtopics; and utilizing the hierarchical topic structure to generate an analysis result.

In some embodiments, the operations restricting potential subtopics to components of contents identified as being relevant to a parent topic for which the subtopics are being derived.

In some embodiments, the operations performing iterative refinement of topics and subtopics for inclusion within the hierarchical topic structure using semantic reduction.

In some embodiments, the operations inputting business context information into the large language model for generating topics and subtopics relevant to a business based upon the corpus of contents.

In some embodiments, the operations utilizing the hierarchical topic structure to identify topics described in employee surveys.

In some embodiments, the operations utilizing the hierarchical topic structure to identify topics associated with at least one of call transcripts, email, or support tickets stored within the corpus.

In some embodiments, the operations utilizing the hierarchical topic structure to identify information associated with customer journeys of experiencing content related to a business; and processing the information to identify factors leading to cancellation with the business.

In some embodiments, a non-transitory machine readable medium is provided. The non-transitory machine readable medium comprises instructions for performing a method, which when executed by a machine, causes the machine to perform operations comprising invoking a large language model to generate initial topics for contents of a corpus; iteratively merging and removing overlapping topics of the initial topics to create a refined set of topics; assigning topics from the refined set of topics to components of the contents, wherein a first topic is assigned to a first component of a content and a second topic is assigned to a second component of the content; invoking the large language model to iteratively assign subtopics to the content, wherein a topic is used as an anchor providing contextual awareness for subtopic generation; generating a hierarchical topic structure including the topics and subtopics; and utilizing the hierarchical topic structure to generate an analysis result..

In some embodiments, the operations include utilizing the hierarchical topic structure to identify topics associated with at least one of call transcripts, email, or support tickets stored within the corpus; utilizing the hierarchical topic structure to generate a hierarchical topic map of customer interactions for analyzing customer relationships and customer needs; generating dynamic contact profiles within a customer relationship management database based upon the topics; and predicting future customer needs based upon topic patterns identified from the topics.

In some embodiments, the operations include utilizing the hierarchical topic structure to automatically categorize and tag content hosted by a multi-service business platform.

In some embodiments, the operations include utilizing the hierarchical topic structure to track topic performance, identify trending topics, and predict future content opportunities of content to provide users.

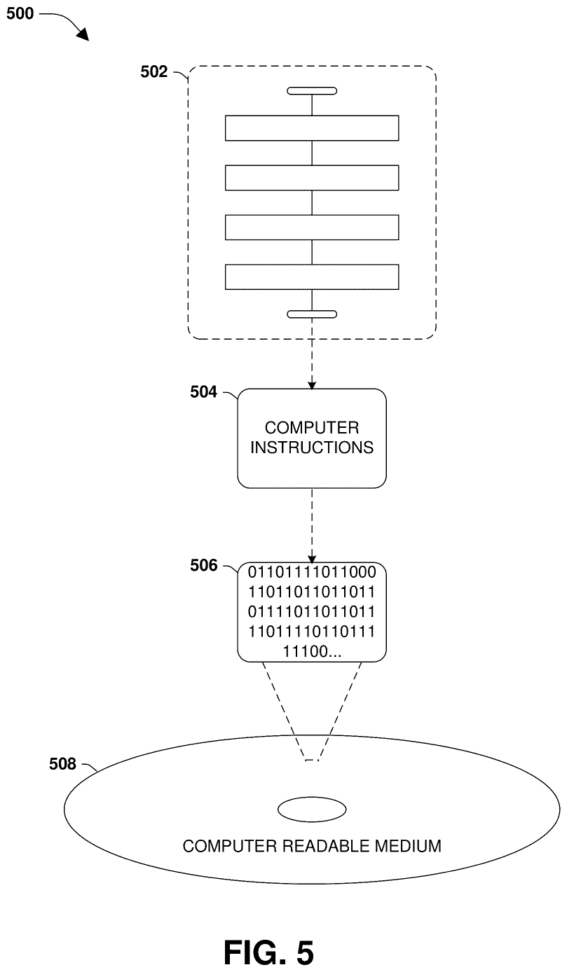

A computer-readable medium comprises processor-executable instructions configured to implement one or more of the techniques presented herein. An example embodiment of a computer-readable medium or a computer-readable device is illustrated in FIG. 5, wherein the implementation 500 comprises a computer-readable medium 508, such as a CD-R, DVD-R, flash drive, a platter of a hard disk drive, etc., on which is encoded computer-readable data 506. This computer-readable data 506, such as binary data comprising at least one of a zero or a one, in turn comprises a set of computer instructions 504 configured to operate according to one or more of the principles set forth herein. In some embodiments, the processor-executable computer instructions 504 are configured to perform a method 502, for example. In some embodiments, the processor-executable instructions 504 are configured to implement a system, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims. As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. A component may reside within a process and/or thread of execution and a component may be localized on one computer and/or distributed between two or more computers. Furthermore, the claimed subject matter may be implemented as a method, apparatus, or article of manufacture using programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Many modifications may be made to this configuration without departing from the scope or spirit of the claimed subject matter.

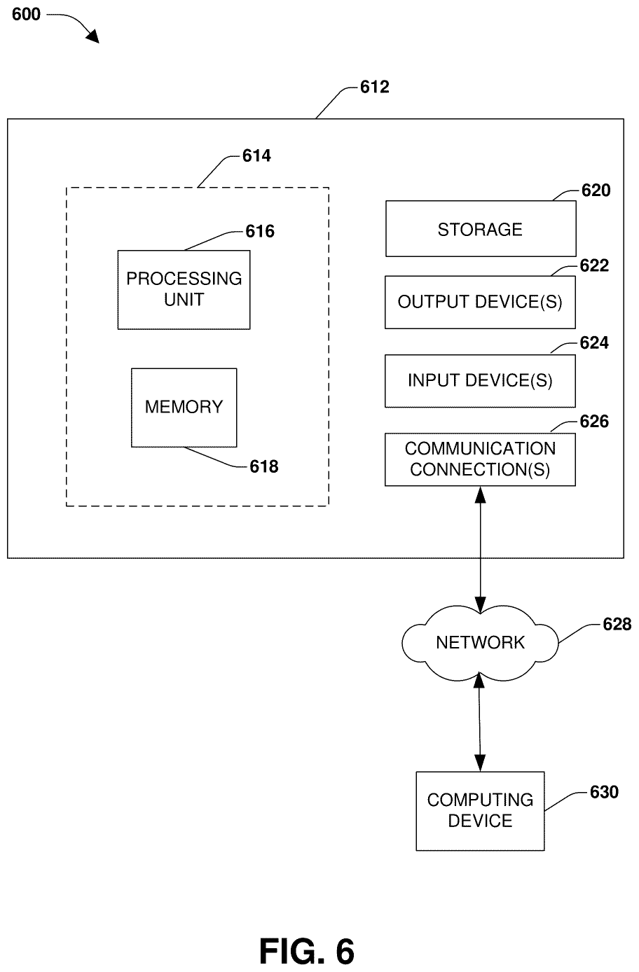

FIG. 6 and the following discussion provide a brief, general description of a suitable computing environment to implement embodiments of one or more of the provisions set forth herein. The operating environment of FIG. 6 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, etc.), multiprocessor systems, consumer electronics, mini computers, mainframe computers, distributed computing environments that include any of the above systems or devices, etc. Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, etc., that perform particular tasks or implement particular abstract data types. Typically, the functionality of the computer readable instructions may be combined or distributed as desired in various environments.

FIG. 6 illustrates an example of a system 600 comprising a computing device 612 configured to implement one or more embodiments provided herein. In one configuration, computing device 612 includes at least one processing unit 616 and memory 618. Depending on the exact configuration and type of computing device, memory 618 may be volatile (such as RAM, for example), non-volatile (such as ROM, flash memory, etc., for example) or some combination of the two. This configuration is illustrated in FIG. 6 by dashed line 614. In other embodiments, device 612 may include additional features and/or functionality. For example, device 612 may also include additional storage (e.g., removable and/or non-removable) including, but not limited to, magnetic storage, optical storage, etc. Such additional storage is illustrated in FIG. 6 by storage 620. In one embodiment, computer readable instructions to implement one or more embodiments provided herein may be in storage 620. Storage 620 may also store other computer readable instructions to implement an operating system, an application program, etc. Computer readable instructions may be loaded in memory 618 for execution by processing unit 616, for example. The term “computer readable media” as used herein includes computer storage media. Computer storage media includes volatile and nonvolatile, removable and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 612. Computer storage media does not, however, include propagated signals. Rather, computer storage media excludes propagated signals. Any such computer storage media may be part of device 612.

Device 612 may also include communication connection(s) 626 that allows device 612 to communicate with other devices. Communication connection(s) 626 may include, but is not limited to, a modem, a Network Interface Card (NIC), an integrated network interface, a radio frequency transmitter/receiver, an infrared port, a USB connection, or other interfaces for connecting computing device 612 to other computing devices. Communication connection(s) 626 may include a wired connection or a wireless connection. Communication connection(s) 626 may transmit and/or receive communication media. The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal. Device 612 may include input device(s) 624 such as keyboard, mouse, pen, voice input device, touch input device, infrared cameras, video input devices, and/or any other input device. Output device(s) 622 such as one or more displays, speakers, printers, and/or any other output device may also be included in device 612. Input device(s) 624 and output device(s) 622 may be connected to device 612 via a wired connection, wireless connection, etc. In one embodiment, an input device or an output device from another computing device may be used as input device(s) 624 or output device(s) 622 for computing device 612. Components of computing device 612 may be connected by various interconnects, such as a bus. Components of computing device 612 may be interconnected by a network. For example, memory 618 may be comprised of multiple physical memory units located in different physical locations interconnected by a network. For example, a computing device 630 accessible via a network 628 may store computer readable instructions to implement one or more embodiments provided herein.

FIG. 7 is a block diagram illustrating an example of unified platform such as a multi-service business platform 700 the includes a customer relationship management (CRM) system, a synchronization system, a machine learning system, a content management system (CMS), a multi-client service system, a customization system, an event system, a payment system, a reporting system, a conversation intelligence system, a custom workflow actions system, a workflow system, an entity resolution system, services (e.g., workflow automation, reporting, CRM-related actions, analytics, import/export, and other actions), and a multi-service business platform (e.g., multi-tenant data stores, proprietary data stores, knowledge graphs, and event data stores), which are further described in U.S. Provisional Patent Application, titled “SYSTEM AND METHOD OF TRANSLATING A TRACKING MODULE TO A UNIQUE IDENTIFIER”, filed on May 13, 2022, which is incorporated herein by reference. The multi-service business platform 700 (the unified platform) may communicate with various devices, services, and information sources over a network.

The platform (the multi-service business platform 700) may serve the needs of multiple clients who in turn use the system to provide services, support, etc. for their customers or end users. The platform includes a Customer Relationship Management (CRM) System, a synchronization system, an Artificial Intelligence (AI)/Machine Learning (ML) system (“AI/ML system”), a content management system (CMS), a customization system, a multi-client servicing system, an event system, a payment system, a reporting system, a conversational intelligence system, a workflow system having a custom workflow actions system, an entity resolution system, a services module and a storage system.

The services module includes a workflow automation service, a CRM related action service, an import/export service, a reporting service, an analytics service and other services. Other services may include, for example, filtering used to search, filter, and list objects (e.g., contact objects) that may be used with other objects and/or create lists for other types of objects. In some examples, other services may include reporting, permissioning, auditing, user-defined calculations, and aggregations.

The storage system includes one or more multi-tenant data stores, one or more proprietary data stores, one or more knowledge graph data structures and one or more event data stores. Custom objects and/or core objects may include information that may be stored in the multi-tenant data stores of the storage system. The custom objects and/or core objects as well as possible relationships (e.g., associations) between objects may be stored in an ontology of the knowledge data structure.

The platform may communicate with external systems and data sources via a communication network (e.g., Internet, public network, private network, etc.). Specifically, the multi-service business platform may communicate with a user device(s) who is using the one or more systems of the platform (e.g. CRM, customization system) to reach their customers who are accessing the user side of the platform (content, ticketing system, etc.) via one or more user device(s). The platform may allow the client to track various activities of their customers (users) for purposes of sales and marketing (e.g. using custom objects).

The platform may refer to a computing system that provides customer service solutions for any number of different clients. As used herein, a client may refer to an organization (e.g., a business, a government agency, a non-profit, etc.) that engages in some form of commercial or service-related activity, whereby the platform may provide a customized or semi-customized customer service solution to service the customers of the client. In embodiments, the platform is a multi-tenant platform, such that the system serves the needs of multiple clients, who in turn use the system to provide service, support and the like to their own customers. As used herein, the term “service” should be understood to encompass, except where context indicates otherwise, any of a wide range of activities involved in providing services to customers and others, such as via various workflows of a business, including providing services for value, servicing goods, updating software, upgrading software, providing customer support, answering questions, providing instructions of use, issuing refunds or returns, and many others. As used herein, except where context indicates otherwise, a customer may refer to an entity or individual that engages with the client (e.g., a purchaser of a product or service of the client, a user of the client's software platform, etc.), and the term “customer” should be understood to encompass individuals at different stages of a relationship with a client, such as individuals/organizations who are being targeted with marketing and promotional efforts, prospects who are engaged in negotiations with sales people, customers who have purchased a product, and users of the product or service (such as individuals within a customer organization). Furthermore, as will be discussed in further detail, the term “contact” is used to describe organizational entities or individuals that do engage with, may engage with, or previously engaged with the client. For example, a “contact” may refer to a sales lead, a potential customer, a closed customer (e.g., purchaser, licensee, lessee, loan recipient, policy holder, or the like), and/or a previous customer (e.g., a purchaser that needs service or may review the organization). In this way, the platform may help track a contact through an entire contact lifecycle (e.g., from the time the contact first comes to the attention of the client as a lead (such as when the client opens a promotional email or clicks on a promotional offer) until the end of the lifecycle of the client's offering(s)). It should be noted that the term contact may refer to a customer, but also to individuals and organizations that may not qualify as “customers” or users of a client.

The platform may also communicate with one or more external information sources that may include company information or data on customers, products, sales, third party data, resource description framework (RDF) site summary (RSS) feeds or really simple syndication (RSS) feeds, telemetrics (e.g., from email, websites, app usage), etc. with respect to custom objects. The platform may also communicate with third party service(s) (e.g., third party applications, websites, data lakes and warehouses, etc.) via network.

The platform may also communicate with integrator device(s). Integrator devices may refer to user devices used by third-party integrator users that may create and may define a series of custom objects that may be integrated with other objects in the multi-service business platform and may be offered to users of the multi-service business platform. The platform may include APIs (as described in the disclosure) that a user may use to define custom objects and integrate those custom objects into the CRM system and thereby into the platform. These same APIs may be available to integrator users to do the same thing. The integrator users may define a series of custom objects, then the integrator users may define object definitions. When a client installs that integration into their instance of the platform, the client may then start creating instances of custom objects defined by the integrators.

In some embodiments, the CRM maintains records of contacts and interactions associated with a particular customer or potential customer, including relevant corporate information, named individuals in significant roles, purchasing history, etc. In some embodiments, the CRM system supports a consistent set of features and information is structured, so that individuals may be associated with corporate roles, and attributes such as progress status may be associated with objects such as product orders. Controlled change procedures may be provided to, as examples, provide auditable logs of information change activity, or to require particular authority to make such changes.

The CRM is configured to access, associate and manage objects which are associated with potential and existing contacts (or customers) which create value to the client user who is using the platform. Contact objects may be considered as people who may communicate with the client (e.g., anyone who may interact with business) such as customers or prospective customers of the business (e.g., people who may convert on a form, people who contact chat team of business, and/or people who met business team at an event). Each contact object may be defined with properties (e.g., a name of the contact, a phone number of the contact, an email address of the contact, a physical address of the contact, a title of the contact, etc.). Contacts may work at companies such that company objects may also be important to represent in data. Company objects may be defined as organizations or businesses that may communicate with a user's organization. Each company object may include properties such as a company name, an address of the company (e.g., main location, headquarters, or the like), and other suitable properties.

A deal object may be considered opportunities that may be available from interactions with contacts (e.g., contact objects) and/or companies (e.g., company objects). Deal objects may be defined as and represent transactions that may be typically between two businesses. Each deal object may include properties such as a sale made by a customer to a company via a contact. Some examples of deal objects may include the amount of a deal (e.g., deal_amount), an estimated close date for a deal (e.g., estimated_close_date), and a likelihood to close a deal (e.g., likelihood_to_close). Likelihood to close may be determined from machine learning. For example, machine learning may be used to take previously closed deals and may create a model around what types of properties (e.g., attributes) and objects may create a highly likely result to close and then may output values based on this predictive machine learning.

In some embodiments, ticket objects may be considered as customer deals, requests for support or help (e.g., service ticket that may relate to a service request that may be issued by a company to a user via a contact). Some examples of properties for ticket objects may include date ticket was opened (e.g., date_opened), priority of ticket, last date custom replied to ticket (e.g., last_date_customer_replied), last date rep replied to ticket (e.g., last_date_rep_replied), etc.

The CRM of the platform is configured to include associations between core and customized objects. For example, each association may be a directed association, such that a respective association may define a type of relationship from a first object to a second object. For example, an association between a contact object and a company object may be “works for” such that the contact object “works for” (association) the company object. When an instance of the contact object (e.g., the contact object instance identifies Bob as a contact) may be associated with an instance of the company object (e.g., the company object instance may identify “Acme Corp.” as a the company) with a “works for” association, then the individual indicated by the company object instance may be defined in the customer databases as working for the company indicated in the company object instance (e.g., Bob works for Acme Corp.).

In example embodiments, two objects may be associated using one or more different types of associations and the associations may be directed in both directions (e.g., association and inverse association). An inverse association of the association may be created automatically for every association. For example, the association in one direction may be “works for” and the inverse association may be “employs” which may be created for the same association automatically. This same association may be viewed from the contact object and viewed from the company object such that the association may be defined as the contact object “works for” (association) the company object or the company object “employs” (inverse association) the contact object. The associations may be between the same types of objects and/or between different types of objects. For example, in continuing the example of the company object and the contact object, a contact object instance may indicate that the company defined by the company object instance may employ the individual defined by the contact object instance vis-à-vis the “employs” association (e.g., Acme Corp employs Bob) and that the individual works for the company vis-à-vis the “works for” association (e.g., Bob works for Acme Corp).

In some example embodiments, two objects may have multiple associations in the same direction. Continuing the example of the contact object and the company object, a contact object may be associated with a company object by a “works for” association, a “previously worked for” association, a “sells to” association, and/or other suitable types of associations. Similarly, the company object may be associated with a contact object with an “employs” association, a “previously employed” association, a “buys from” association, and/or other suitable types of associations. In this way, different types of relationships between instances of objects may be defined within the customer's databases.

In example embodiments, objects may also have the same object type directed associations. For example, a contact object may be associated to itself with one or more directed associations, such as a “is supervised by” association, a “supervises” association, or the like. For example, if Bob and Alice may work for the same company and Alice may supervise Bob, then an instance of a contact object that may define Bob may be associated with a contact object instance that may identify Alice with a “is supervised by” association (e.g., Bob “is supervised by” Alice) and/or Alice's contact object instance may be associated with Bob's contact object instance with a “supervises” association (e.g., Alice “supervises” Bob).

The contact data record may include a contact ID, a client ID, a purchase data, ticket IDs, a contact timeline, and contact data. It is noted that the contact record may be used across multiple platforms, such that the contact record defines data relevant to the contact through the lifecycle of the contact (e.g., from new lead and/or buyer through customer service). In an example aspect, the client's customer service function may be integrated with the sales arm of the client's business. For example, the contact record corresponds to a warehouse manager (a contact or end user) that purchased an industrial furnace from an HVAC business (a client) may identify or otherwise reference the dates on which the warehouse manager was first contacted, all communications sent between the manager and the HVAC business, a product ID of the furnace, and any tickets that have been initiated by the contact on behalf of the warehouse, etc. Thus, in some embodiments, the integration of the client's sales and marketing data with the client's customer service infrastructure allows a client-specific service system to address issues with a more complete view of the contact's data and reduces the need for APIs to connect typically unconnected systems (e.g., invoicing system, CRM, contact database, etc.). The foregoing database object is provided for example. Not all the data types discussed are required and the object may include additional or alternative data types not herein discussed.

The contact identifier (or “contact ID”) may be a unique value (e.g., string or number) that uniquely identifies the contact (user) from other contacts which the client has a probable or existing business relationship with. It is noted that the client ID is specific to a relationship between a contact and a client, whereby the contact may only relate to a single client, although the contact may related to more than one client.

If a certain individual interacts with multiple clients, then the contact may have multiple contact records associated therewith (i.e., one for each client, where the contact is a customer of different clients (businesses) for the respective products or services of the businesses). The client ID indicates the client to which the contact corresponds. In embodiments, the client ID may be a reference to the client record (e.g., client database record). In this way, the client ID defines the relationship between the contact end user and the client.

In some embodiments, purchase data indicates some or all of the purchases made by the contact end user for a respective client. In some embodiments, the purchase data may represent one or more products and/or services purchased by the contact and the dates on which such products or services were purchased from the client. In some embodiments, the products and services may be presented by product IDs which are unique identifiers for each product/service that is offered by the client.

The ticket IDs indicate any tickets that have been issued with respect to the client. In embodiments, the ticket IDs include any tickets, resolved or unresolved, that have been issued with respect to the contact for a particular client. In an embodiment, the ticket IDs may only include the tickets IDs that are still open. More details about ticket IDs are discussed below with regard to the ticketing system.

In some embodiments, the contact timeline represents data relating to a timeline documenting the contact end user's interaction with the client. The contact timeline may include data from the point in time when the contact was solicited as a lead, when purchases were made by the contact, when tickets were generated on behalf of the contact, when communications were sent to the contact, etc.

In some embodiments, contact data object may include any data that is relevant to the contact end user customer with respect to a particular client of the platform. The contact data may include demographic data (e.g., age and sex), geographic data (e.g., address, city, state, country), conversation data (e.g., references to communications that were engaged in with the client), contact information (e.g., phone number, email address, user name), etc. Contact data may further include information such as a date that the contact was entered into the system, lifecycle state (what is the current relationship with the contact—current customer, lead, or service only), last purchase date, recent purchase dates, on boarding dates, in-person visit dates, last login, last event, last date a feature was used, demos presented to the contact, industry vertical of the contact, a role of the contact, behavioral data, net promoter score of the contact, and/or a contact score (e.g., net value of the contact to the client or a net promoter score).

Accordingly, contact data and the timeline data can be configured to provide a rich history of all interactions of the contact end user and the client over the lifecycle of their relationship. As a result, an individual, such as a salesperson or service professional, of the client using the platform can understand and reference that history for one or more end user to provide relevant communications to them.

In some embodiments, the client record may include the client ID and one or more product IDs. The client ID may be a unique value (e.g., string or number) that uniquely identifies the client from other clients that have accounts in the platform. The product IDs identify/reference products (e.g., goods, services, software) that are offered by the client. The product ID of a product may reference a product record (not shown) that includes data relating to the product, including warranty data, serial numbers, descriptions, product names and the like.

A ticket database record or ticket object is utilized and managed by the CRM system of the platform in accordance with an aspect of the present disclosure. In some embodiments, the ticket database record may include a ticket ID, the client ID, a contact ID, one or more ticket attributes, one or more status attributes, and other additional ticket data. In some embodiments, the ticket object stores data associated with the types of ticket attributes that may be used to identify, track, and/or manage a ticket issued to an end user contact on behalf of the client. The ticket ID is a unique value (e.g., string or number) that uniquely identifies each ticket from other tickets that may be associated with contacts of the client. In a ticket object, the client ID is a value that indicates the client with respect to which the ticket was issued. As can be appreciated, the client ID may point to the client database record and/or the contact record for a particular client. The contact ID uniquely identifies the contact that initiated the ticket for the particular client. As can be appreciated, the contact ID may point to the client database record of the contact that initiated the ticket.

The ticket attributes may include or reference any data tied to the ticket. As discussed, the ticket attributes may include default ticket attributes and/or custom ticket attributes. Examples of default ticket attributes may include a ticket priority attribute (e.g., high, low, or medium), a ticket subject attribute (e.g., what is the ticket concerning), a ticket description attribute, a pipeline ID attribute, a creation date attribute, a last update attribute, etc. The custom ticket attributes may depend on the customizations of the customer contact for a particular client.

In an example, the ticket attributes may be customized to include a ticket type attribute indicating a type of the ticket (e.g., service request, upgrade request, refund request, lost items, etc.), a contact sentiment attribute indicating whether a sentiment score of a contact (e.g., whether the contact is happy, neutral, frustrated, angry, etc.). In some embodiments, the ticket status attribute may include a sentiment or tone of the contact throughout the timeline, feedback from the contact, a contact score of the client, etc. In some embodiments, the product ID attribute indicates a product to which the ticket corresponds, a contact frequency attribute indicating a number of times a contact has been contacted, a media asset attribute indicating media assets (e.g., articles or videos) that have been sent to the contact during the ticket's lifetime, etc.

In some embodiments, the ticket attributes may further include the ticket status attribute. The ticket status attribute can indicate a status of the ticket, whereby the status may be defined with respect to the ticket pipeline for the client. For example, example statuses may include: ticket is opened but not acted upon, waiting for customer response, at a chatbot stage, at service specialist, at visit stage, at refund state, issue resolved, etc.

In some embodiments, the ticket object may include additional ticket data in accordance with the CRM system of the present platform. In embodiments, the additional ticket data may include or reference the specialist or specialists that have helped service the ticket (e.g., employee IDs), any notes entered by specialists, a number of notes entered by the specialists, a list of materials that have been sent to the contact during attempts to resolve the issue, etc. In some embodiments, the additional ticket data may include references to transcripts of conversations with the contact over different mediums or knowledge base articles referred to during the handling of a ticket. For example, the additional ticket data may include or reference conversations had with a chatbot, over email, telephone call, in a WhatsApp message, SMS text message, social media posts, and/or other communications with the client's customer service specialist. The additional ticket data may additionally or alternatively include analytics data.

In some embodiments, the additional ticket data may include or reference a ticket timeline (not shown) in accordance with the CRM system. In some embodiments, a ticket timeline may indicate all actions taken with respect to the ticket and when those actions were taken by the client. In some embodiments, the ticket timeline may be defined with respect to a client's ticket pipeline and/or workflows managed by the client. The ticket timeline may identify when the ticket was initiated, when different actions defined in the workflow occurred (e.g., chatbot conversation, sent link to FAQ, sent knowledge base article, transferred to customer service specialist, made house call, resolved issue, closed ticket, etc.).

The ticket timeline of a ticket record may be updated each time a contact user interacts with the client's platform instance for a particular ticket. In this way, many different types of information can be extracted from the ticket timeline (or the ticket record in general). For example, the following information may be extracted: How long a ticket took to come through the pipeline (e.g., how much time was needed to close the ticket); how many interactions with the system did the contact have; how much time passed until the first response was provided; how long did each stage in the pipeline take; how many responses were sent to the contact; how many communications were received from the contact; how many notes were entered into the record; and/or how many documents were shared with the contact.

The platform may include a customization system which gives client users the ability to create custom objects and have the flexibility of creating any type of custom object relevant to their business without being restricted to the core objects. This allows for clients to customize usage of the framework more closely to their business with regard to marketing, sales, and/or customer service. This also may allow for improved and faster development of new custom object types by clients and/or developers of the framework. The ability to create custom objects within the multi-service business platform may speed up development of new types of custom objects for the platform. In some examples, the customization system may be a separate system from the multi-service business platform and may communicate with the multi-service business platform (e.g., via external application programming interfaces (APIs)).

Various services of the multi-service business platform may be applied and/or used with custom objects. For example, some services that may be applied include workflow automation, wherein an example is automating based on changes to core objects and based on added custom objects or changes to custom objects and/or core objects. For example, the workflow automation may be used to add verbs (automation actions) with respect to nouns (e.g., custom objects). Another service includes a reporting service, such as creating and displaying reports on any custom objects along with core objects), CRM-related actions (e.g. to manage the CRM), analytics (e.g., get analytics for custom objects), import/export from/to third party services and/or databases, and/or other actions or services (e.g. filtering used to search, filter, list contact objects used with custom objects, create lists for custom objects). In example embodiments, other services may include, but are not limited to, reporting, permissioning, auditing, user-defined calculations, and/or aggregations.

Custom objects may be defined as purposely non-prescriptive objects (e.g., flexible/customizable in contrast from fixed core objects). A client may create custom objects relevant to their business and the user's business needs. The custom objects may provide an alternative where objects of interest to businesses may not fit smoothly within core objects (e.g., not necessarily fit as contacts, companies, deals, and/or tickets). The user may create custom objects that may be particularly useful to one or more services (e.g., workflows, reporting) of the multi-service business platform as described in the disclosure.

Each custom object or custom object definition may include an object type, properties (e.g., some properties may be set on an instance), and possible associations. In example embodiments, custom objects and/or types of custom objects may include products, goods such as devices/machines (e.g., cars, drones, boats, mobile phones, etc. such that these devices/machines custom objects may be used to track details about ownership, service, cost of devices/machines), business services, shipments (e.g., may be used to store data about fulfillment of orders that may be intended to be sent out), applications (e.g., may be used to store data that tracks progress of an application), projects (e.g., may be used to store data about work or deliverables), locations/stores (e.g., may be used to store granular data about companies and their many physical locations such as store locations and/or company headquarters location), customer locations (e.g., may be locations of customers that buy products and/or services from user's business), events (e.g., may be used to store and track physical or online events a company holds), listings (e.g., may be used to store data about real estate listings for a real estate company), referrals (e.g., may be used to link two things together to notate a referral or referrer), etc. Some businesses may have unique relationships from operating in an agency type model that the businesses may want to identify, monitor, and/or track using custom objects.

Custom objects may provide users with the ability to model their business. For example, custom objects may allow users to model their own version of contacts, companies, deals, and/or tickets or any other type of object for their businesses that may allow the users to customize what they want for objects and/or object types. The custom objects may be used with the multi-service business platform such that the upstart of the platform may provide various functionality for usage of these custom objects. When a user may build a custom object, the user may utilize all services (e.g., features) of the platform such that the user (e.g., user's business) may use these services throughout the platform towards relevant custom objects that may match user's business needs.

In some examples, users may create custom objects with respect to usefulness with services of the multi-service business platform. For example, an auto manufacturer user may create car or vehicle custom objects that may fit into the auto manufacturer's business workflows (e.g., workflow automation) that may be used on the platform. In another example, a user may choose to add custom objects that may be particularly useful with reporting service for user's business needs.

In general, this ability to create custom objects provides increased and improved customizability across the multi-service business platform. This provides several advantages to the platform as described in the disclosure. For example, some advantages may include customization for users with respect to their business industry or field, specific customization towards each user's business itself such that one user in a business industry (e.g., car industry) may have different custom object needs with respect to another user in the same business industry, increased speed of development of various new types of objects by users and by developers of the multi-service business platform, etc.

Using a yoga business as an example (e.g., where the user may be a yoga business owner), the user may create custom objects towards their yoga business (e.g., where the yoga business may include multiple studios that may be staffed with multiple instructors that may teach different classes that may be taught to students in accordance with the instructors'respective schedules). In this example, a user (e.g., a user affiliated with the yoga studio or a third-party consultant) may create (e.g., via a GUI) a set of custom objects that relate to the yoga business, including defining the properties of each custom object. For example, the custom objects created may be studio objects, class objects, instructor objects, student objects, and schedule objects. Each studio custom object may include properties such as address of studio, rent of studio, and date when studio opened (e.g., date_opened). Each class custom object may include properties such as name of class, price of class, and schedule of class. Each instructor custom object may include properties such as date when instructor was hired (e.g., date_hired), latest certification date of instructor (e.g., latest_certification_date), certification expiration date of instructor (e.g., certification_expiration_date), and number of classes taught by instructor (e.g., number_of_classes_taught). Each student custom object may include properties such as date joined by student (e.g., date_joined), number of classes attended by student (e.g., number_of_classes_attended), date last attended a class by student (e.g., date_last_attended_a_class), total lifetime value of student (e.g., total_lifetime_value), credit of student, address of student, and phone number of student.

In some embodiments, the client may define a set of associations between objects (e.g., custom objects and/or core objects). This yoga example may include several examples of associations. For example, one association may be “class_taught_by” which may be between the custom object instructor and/or a contact object (e.g., where contact may be instructor) and the class custom objects that the instructor teaches. Another example association may be “taught_at_location” which may be an association between the class custom object and the studio custom objects based on where a particular class may be held (e.g., may be determined from address or location information properties of studio custom objects). In another example, the “taught_at_location” association may be an association between the instructor custom object and the studio custom objects based on at which yoga studios a particular instructor teaches. There may be other associations created between instructor custom objects and core objects (e.g., contact objects) as well as student custom objects and core objects (e.g., contact objects). This may allow for actions to be taken based on these associations such as emails to be sent to instructors and students based on the associations of instructor custom objects and student custom objects with contact objects.

In example embodiments, AI/ML system of the platform may be used with custom objects to determine a likelihood to attend based on custom objects and properties that may be created. For example, the multi-service business platform may provide prompts for a user to define inputs into a machine learning model, e.g., the user may submit via prompts several properties (e.g., how often does student attend, how many classes is student signed up for, subscription plan, etc.) that may impact whether a student may be likely or unlikely to attend a class and the machine learning model may be used to perform calculations based on these inputs. In other example embodiments, the machine learning model may determine insights (e.g., properties relating to attendance may be determined) as data may be received from instances of the occurrence of actions relating to instances of the custom objects. For example, instances of associations between the object instances (e.g., between custom object instances and/or core object instances) may be used to determine these properties (e.g., based on properties of the association instances).

In the yoga example, an integrator may have a company that builds CRM integration for yoga studios. This company may not be a yoga studio itself but may provide the CRM integration. For example, the integrator may define a set of custom objects (including properties) that may be used by yoga studios or other fitness class-based businesses. The custom objects may include a studio custom object, an instructor custom object, a student custom object, a class custom object, and a schedule custom object. In this example, any client of the platform that operates a yoga studio (or other fitness, class-based business) may use the custom objects defined by the integrator (e.g., for a fee to the integrator) when on-boarding their business to the platform. For example, the yoga studio users (e.g., from yoga studio businesses) may install integration (e.g., CRM integration from the integrator user) to be used on the platform. After integration, the yoga studio users may be able to take advantage of the custom objects (e.g., custom definitions of the custom objects) created by the integrator user such as the “yoga class” custom object, the “yoga instructor” custom object, and the “yoga student” custom object. The yoga studio users may also have access to the services of the platform such as reporting (e.g., user reports), workflow automation (e.g., user workflows), etc. that may be used with these custom objects. It may be as if each yoga studio user may rely on the integration from the integrator user such that the integration may be packaged with the custom objects and definitions for users of the platform.

A system of the multi-service business platform may include a registration system (that may include a registration definition service) connected to a storage system and to a customization system (that may include a registration definition service) via a set of APIs. The registration system (and registration definition service in some examples) may be used to create and use registration objects. The customization system may include the registration definition service for creating and/or generating registration objects. Further, similar to the organization of customized objects, an ontology may include registration objects and/or definitions and an instances knowledge graph that may include registration object instances. The storage system of the multi-service business platform may include a knowledge graph that facilitates associating core objects (e.g., campaign core objects) and associations with registration definitions and customized objects via the ontology. The knowledge graph may further facilitate associating core object instances with association instances, custom object instances, and registration instances via the instances knowledge graph.

In embodiments, a multi-service business platform may be organized around an object-oriented database, such as a customer relationship management (CRM) database. Such a CRM database may include a range of data objects (e.g., types of objects) that each contain several data fields and corresponding field values that may be configured for a purpose, such as operating an advertising campaign, tracking correspondence, etc. One or more of these data objects may be instantiated as a variety of object instances that effectively replicate a structure of the data object with instance-oriented values. An advertising campaign object type structured with a “campaign_name” field may be instantiated as a first instance of a “campaign” type object with a value of “first” attributed to the “campaign_name” field and a second instance with a value of “second” attributed to the “campaign_name” field.

In embodiments, structures of objects and values assigned to fields of such structure in a CRM may be configured for core functionality of a multi-service business platform. However, the content of these objects may be utilized in various projects, applications, and contexts, such as a calendar, CRM activity monitoring, CRM performance, export to/from 3rd party platforms, etc. Further, not all such uses, applications, and external systems may be directly compatible with the structures and content of objects in the CRM database. As an example, a campaign type object may include a “campaign start date” field with a mmddyyyy structured content. A calendar application (e.g., using a calendar system service) may require a minimum set of information about a campaign to ensure that it may be displayed properly in a visualization of a calendar that may display campaign activities and other information. Such a calendar application may require a “start date” attribute in the form of “yyyymmdd” to visualize activities. Therefore, it may be beneficial for some type of easily-performed adaptation to occur when a calendar application is requested/instructed/automated to display the campaign type object (and related activities). The registration pattern systems and processes described herein may facilitate this adaptability through new and interesting uses of elements stored in a CRM database. In general, new types of CRM database elements, referred to herein as one or more of a “registration definition element” or a “registration association element”, may provide a standardized approach for enabling a range of database content utilization, maintenance, and access capabilities. When these new types of registration data structures (herein registration elements) are stored in a database, such as in a database of a multi-service business platform, such a database may be configured to be self-adapting for new and interesting uses, such as CRM-powered applications, third-party applications, interfacing the CRM with other portals, other systems, CRM object maintenance, etc.

In example embodiments, a registration definition or a registration association may optionally be stored within (or in association with) a customer relationship management (CRM) data set. Stored registration definitions and/or registration associations may be referred to herein as registration elements. While registration elements may be embodied similarly to one or more objects in the CRM data set, use of the term “element” herein when applied to the term “registration” (e.g., a registration element) may connote a data item/structure stored in or in association with a CRM that may embody content, structures, attributes and the like that may not be fully compatible with other objects of the CRM. In example embodiments, registration elements may allow, among other things, other (optionally pre-existing) objects (e.g., customized objects and/or core objects) to be adapted for new uses and processing without forcing use and/or processing constraints that may require altering the pre-existing objects. A benefit of using registration patterns may be that these new and adapted uses may occur without requiring new code to be written (or existing code to be modified) for each such use. Use of registration patterns may also eliminate needing to create use-specific shadow objects in the CRM. For example, allowing a pre-existing CRM object (e.g., webinar object, seminar object, campaign object, etc.) to be processed for display by a calendar application may occur. In example embodiments, as described in the disclosure, core objects (e.g., which may be predefined) may include contact objects, company objects, deals objects, and ticket objects. New objects that may not be predefined objects may be referred to as customized objects. In some examples, the webinar object may be a unique object (e.g., portal specific object) that may be similar to a custom object.

In embodiments, an aspect of registration pattern systems and processes functionality may be using registration elements, optionally stored in the CRM, to configure a CRM powered application. This may enable the CRM to have its own configuration and adjustment mechanism, which may make processes easier for customers who want to closely integrate with the CRM and which may be simple for integrators. In example embodiments, one benefit may be that all access may be made through a single application programming interface (API) or another programmatic interface. In some examples, a second system for managing interactions with the CRM may not be required for various applications, services, and third-parties to interact with the CRM. Providing access to the CRM through a single API or other programmatic interface may eliminate such second systems using a separate database to hold configuration information for these types of CRM interfacing processes.

In an example, an integrator uses a specific data structure for defining an online university course object, and the integrator prefers that these types of courses show up in a calendar application (e.g., rendered on the CRM-powered calendar application such as to announce when the courses were being taught). The integrator may create a registration definition (e.g., registration schema for some examples). The integrator may optionally store this registration definition as a registration element in the CRM. Use of this registration definition, such as by the single API in the disclosure, may enable the calendar application to interpret the integrator's specific data structure to facilitate rendering course information in a calendar. The integrator course object may be rendered as a fully-fledged, fully integrated object in the calendar. Using registration definitions as a form of registration patterning may be used with other types of CRM-powered applications, such as a campaign application. With use of a campaign application compatible registration definition (e.g., a registration definition that facilitates mapping content/fields of the specific course object to campaign object content/fields), a course object of the integrator may appear to a campaign application as if it were integrated.

The registration pattern system and process may avoid the need for a two-system approach. While the examples herein may be based on online types of events (e.g., university courses, blog posts and the like) support for offline events (e.g., events that may not have an online component but may be physical events), for example, may be captured and supported by the registration pattern systems and processes described herein. In example embodiments, a registration definition element instance may be tied to a target consuming application-specific registration pattern that may be applied against several types of CRM objects (e.g., seminars, webinars, blog posts, emails, campaign elements, etc.).

In example embodiments, a registration association may be a registration pattern variant (optionally stored as a registration element within the CRM) that may allow for, among other things, establishing/maintaining continuity of content and structure of related objects in the CRM based on monitored CRM events, such as changes to one or more objects in the CRM (e.g., a change in an email distribution date). Use of registration associations when monitoring CRM events may facilitate factor-based CRM reporting across a CRM-based multi-service business platform and the like, for example. In example embodiments, being able to tie a registration association across the platform framework may facilitate reporting on various factors that may impact more than one CRM object. In example embodiments, data and information in a CRM data structure (e.g., a distributed database and the like) may be associated with one or more objects. In example embodiments, given a list of customers, each individual customer may be represented by their own CRM object. Similarly for a list of blog posts, each blog post may be represented by its own CRM object. From this perspective of managing elements in a CRM data set, registration patterns (e.g., definitions, associations, etc.) may be similarly configured or structured. For example, a calendar registration definition (e.g., referred to herein as a calendar registration definition element instance) may be stored in the CRM; however, this calendar registration definition may be a different type of object compared to an object type for use by a campaign application.

In example embodiments, registration patterns may allow for providing support for new types of data to a calendar, such as webinar data. When a CRM object for a webinar is ready, an administrator may create a calendar registration definition for the webinar object that may, for example, facilitate use of information in the webinar object by a CRM-powered calendar application. In example embodiments, this webinar object-to-calendar application registration definition may contain a field that identifies that it is for the webinar object type. In example embodiments, a start date may be a field on the webinar object (e.g., color coded start date such as yellow by default when rendered in a calendar application). Another webinar object field may capture the title. A webinar may be a recurring item such that there may be another field regarding how often the webinar occurs. In example embodiments, a webinar object (or other CRM object) may have up to ten (10) or twenty (20) or more different data fields to which a corresponding registration definition (e.g., a webinar-to-calendar registration definition) may be applied for integrating the webinar object with a CRM-powered application, such as the exemplary calendar application. In example embodiments, for each distinct type of object to be rendered on a calendar, there may be a separate registration definition. For example, there may be one registration definition for blog posts, one registration definition for website pages, one registration definition for tasks, one registration definition for campaigns, etc. In example embodiments, this may be accomplished in a database table. In example embodiments, there may be separate registration definitions for each type of data (e.g., CRM object, such as a webinar object) to be rendered in a calendar. A database table may include a calendar application row that identifies what types of data may be provided to the calendar. It may also identify minimum required information to be provided to a calendar application so that an object may be displayed on the calendar. This information may be used to query the CRM data set for webinar objects to be rendered in the calendar.

One advantage to having all of this data and information in a single CRM and using a CRM object-like element to store a registration pattern data structure may be that there is no need to give outside vendors, integrators, or customers access to two different systems (e.g., the CRM and the separate database noted in the disclosure). Further, this may all be performed through a common set of APIs (and in some example embodiments a single API) used to access the CRM. In an example, rather than having to access the CRM to populate a bunch of data into a data set, and then logging into a web page (e.g., that includes a control panel) to arrange the data in the data set for configuring a calendar application, or rather than requiring access to two different APIs (e.g., one API for the CRM and one API for the calendar), use of registration patterns may facilitate accessing the CRM and configuring the accessed CRM data for use by a calendar without needing resources external to the CRM. Once granted access to the CRM through, for example, a customer portal, an integrator may create new CRM objects and corresponding registration definitions to keep processes running smoothly.

A registration system (that may include a registration definition service) connected to a storage system and to a customization system (that may include a registration definition service) via a set of APIs. The registration system (and registration definition service in some examples) may be used to create and use registration patterns. The customization system may include the registration definition service for creating and/or generating registration elements. Further, similar to the organization of customized objects, an ontology may include registration associations and/or registration definitions and an instances knowledge graph that may include registration definition and/or association element instances. The storage system of the multi-service business platform may include a knowledge graph that facilitates associating core objects (e.g., campaign core objects) and associations with registration definitions and customized objects via the ontology. The knowledge graph may further facilitate associating core object instances with registration association element instances, custom object instances, and registration element instances via the instances knowledge graph.

In example embodiments, the systems and processes of registration definitions described herein may include features that relate generally to a registration pattern with respect to a customer relationship management (CRM) system (also referred to as CRM). In example embodiments, the CRM may include customer objects, content objects (e.g., blog post CRM objects), registration definitions (e.g., calendar registration definitions), etc. When a “new” (e.g., new to a calendar application) type of object in the CRM (or new to the CRM) may be added to an application (e.g., calendar application), registration definition information may be updated or created for this “new” type of object (e.g., based on registration definition types such as a webinar definition type). When data of a CRM object that has not previously been used by a CRM-powered application (e.g., calendar application) is used, corresponding registration data may be updated. In this example, a registration definition element instance (e.g., within a calendar application registration definition element) that may be linked to the CRM object (e.g., based on the CRM object type) may be updated to reflect how this previously not relied upon data is to be handled by the calendar application.

In embodiments, registration definitions may map attributes of a source object (e.g., Email sent date) to generic fields required by an application (e.g., start date for an event in the calendar application). Further, registration definitions may include a set of definitions on how to process items. Yet further, in addition to mapping data, registration definitions may also contain configuration information for instructing applications about use of these registration definitions, such as one or more conditions that may need to be present in a corresponding definition and/or object (e.g., a master registration definition activate/deactivate parameter value) for the registration definition to be applied. Further, use of specific features of a registration definition may be conditionally applied based on similar feature-specific context. In this way, an entire registration definition may be disabled or only portions of it may be disabled while others may be enabled. In embodiments, registration mappings and definitions may be utilized for different types of registration patterns. For example, a marketing calendar may support a campaign object type as depicted in a user interface (UI) filter that may allow a customer to display the campaign object or not by adjusting a field in the UI. The UI may display a code that the campaign object may be currently enabled for the calendar application use. Adjusting the field in the UI may send a request to the platform for disabling it from being rendered in the marketing calendar so that the campaign object may not appear anymore. Such a UI may be useful because this process of enabling/disabling does not apply only for enabling or disabling an object type but may also be used for changing a property in order to show the proper name or the like. In some examples, to bring campaigns back on the marketing calendar, the system may be used to do the inverse and change the UI field to set it to “enabled”. In embodiments, relying on the UI for registration patterns, which are described in the systems and processes herein, may allow for configuring a CRM object type for a given example in a relatively dynamic way. In embodiments, the UI and the like may rely upon APIs to effectively make the changes described in the registration definitions (e.g., enable/disable rendering of a campaign object in a marketing calendar).

In embodiments, this dynamic configuration mechanism may be used for dynamic association of assets with campaigns through use of a campaign registration association. In embodiments, different registration patterns may be used for the campaign association at least because a campaign may not require all the fields that a calendar requires. In embodiments, similar processes may be applied here to disable use of an asset in campaigns so that the asset may not get associated with campaigns. In examples, a user may merely use the UI to disable this registration. In embodiments, some other information from an asset may be needed for fulfilling the campaign association.

In embodiments, use of a registration definition and/or association may be activated or deactivated through use of one or more properties of an object, such as a scope property. In example embodiments, when visualizing a marketing calendar, for example that may not have a “MARKETING EMAILS” scope property defined, all the marketing emails may not be accessible to the calendar (e.g., not returned by use of a registration pattern). In example embodiments, use of some features for activating and deactivating use of registration patterns may depend on the user or the portal, which may be using/looking at the current calendar. In example embodiments, another approach for enabling and disabling use of registration patterns may include a gating strategy. In example embodiments, a concept of gating, for example, for release of a new feature, may allow for controlled release of the feature across one or more of the portals. Gating may enable gradually releasing of the feature for different portals, such as in order to have control over bugs or some problems that the new feature may introduce. In embodiments, gating may be enabled by a registration being configured with a gate name property. If a registration pattern includes a gate name property (e.g., “BETA”), and a portal (e.g., consuming application and the like) may not be enabled (gated) for using this BETA feature, it may not access portion(s) of objects defined in this “gated” registration. If the application/portal is enabled for, “BETA” features, the corresponding registration pattern may be used to facilitate access to object content gated by this feature.

Another mechanism by which registration aspects may be activated/deactivated and/or enabled/disabled may include use of optional properties in a registration data structure. In example embodiments, a consuming application, such as a calendar application may identify object properties as being optional. A property that is optional may be processed by the registration pattern, but if it is not available in the source object being processed, the property may be ignored when rendering the object in a calendar, for example. Although optional properties are not mandatory per the target consuming application, when they are present and when there is a value for them in the source object, the optional properties may enable specific features for an application (e.g., for a marketing calendar application and the like).

Records may be created in the customer relationship management (CRM) database to register other records (e.g., email, contact, company) with CRM powered applications. This may be compared to other approaches including, without limitation, an external set of mappings or target consumer-specific CRM-processing code. The techniques described herein for registration patterns may power the CRM by using its storage and access capabilities and functions as a plug-in mechanism. This may further benefit the CRM because the registration elements may be created substantially similar to the way that a custom object may be created, which in turn may be slightly different from a non-custom object (e.g., core object). In example embodiments, differences between creating a custom object and a non-custom object may include who may be allowed to do it (e.g., user-based determination), and for example, what set of permissions a user may have, otherwise it may be substantively a similar technical process. In substantially the same way that a customer or an integrator or a vendor may create a custom object, the systems and processes of registration patterns described herein may facilitate in creating a registration element which in turn may enable at least one of a custom object or even a standard object to interact with an application. A characteristic of the registration pattern may be that it may be used for a range of CRM objects, standard objects, and/or customized objects to provide CRM object content to a specific application feature. In example embodiments, a registration structure itself may not be a CRM object such that the registration structure may be stored in a home database. However, in example embodiments, the registration structure may be a CRM object itself. In example embodiments, there may be distinct registration elements for the standard objects and registration elements for the customized objects. In example embodiments, these objects may be stored in the CRM. In example embodiments, these objects may be portal specific and may be replicated across one or more of the portals.

In embodiments, a registration pattern may include a registration definition element that may be stored in a database, such as a CRM database. A registration definition element (also referred to herein as a registration definition) may allow pre-existing objects of the CRM (e.g., customized objects, core objects, object types, etc.) to be adapted for new uses and consumed by processes (e.g., onboarding a CRM asset to a project/application) without any of the following: (i) forcing use and/or processing constraints to require altering the pre-existing objects; (ii) requiring new code to be written and/or existing code to be modified for such use; and (iii) needing to maintain use-specific shadow objects in the CRM (e.g., that may contain at least a portion of the object being shadowed in a use-specific format). A registration definition may be configured to ensure that content from a CRM asset may meet consumer application-specific (e.g., a CRM-powered application, such as a calendar) requirements for content, format. Registration patterns may facilitate reduced computational resources, reduced data storage resources, and reduced network activity when onboarding new assets or when changing behaviors of assets already onboarded to (e.g., used by) a project/application. In an example, registration definitions as described and depicted in the disclosure may allow a pre-existing CRM object (e.g., webinar object, seminar object, etc.) to be processed for display by a calendar application, even when the pre-existing CRM object may include structures, formats, content, or the like that may not be fully compliant with calendar application input or use data requirements. Each type of project/application that consumes CRM data may be associated with a registration definition that may be specific to the project/application. This association may be one-to-one, with each project having a one-to-one association to a specific registration definition element in the CRM. This association may be one-to-many, optionally based on, for example, a type of project. With a one-to-many relationship, several instances of a project type “calendar” all share a single registration definition element.

In embodiments, a registration definition element that may be associated with a target project/application may include registration definition element instances (e.g., discrete portions of the registration definition element) for several types of CRM objects (e.g., seminar objects, webinar objects, blog posts, emails, campaign elements, etc.). A registration definition element instance may be seen as a configuration read by a project when handling a specific object type. In embodiments, a registration element instance may identify a set of criteria for CRM-sourced content to be consumed by, for example, a CRM-powered application. While this set of criteria may be consistent within the consuming application for at least a subset of all object types in the CRM, different object types in the CRM may store the consuming application's required information differently (e.g., may use different field names, may store the content in different formats, etc.). Therefore, while the required content may be consistent, a pattern by which information from the different types of objects may be registered may be different, resulting in, for example, source object dependent registration patterns.

In embodiments, a registration pattern may include a registration association element that may be stored in the database. A registration association element (may also be referred to herein as a registration association or in certain contexts an association) may be a variant of a registration pattern that allows establishing and/or maintaining continuity of content and/or structure of related pre-existing objects. This registration pattern variant may facilitate CRM database continuity through identifying objects and one or more fields therein to be monitored for change. In embodiments, a registration association element may be employed with a process for monitoring a CRM event stream (e.g., a log of events and/or active event stream) to facilitate detecting changes to objects in the CRM. A CRM event stream may include a CRM event (e.g., a change to a value in an object in the CRM) that matches at least a portion of content of a registration association may signify a change in the CRM that triggers a monitoring application to cause further CRM events to occur to ensure continuity in the CRM. An object type of “blog” may include a “source” field label that may be used by CRM-powered applications (e.g., ad campaign administration). A registration association element may be configured with this object type and this field label. Responsive to a CRM event monitoring application detecting a CRM event (e.g., in an event stream) that matches this registration association element, the monitoring application cause instances of the “blog” type object to be updated based on a change in the monitored field “source”. Use of registration associations when monitoring CRM events may facilitate factor-based CRM reporting (e.g., CRM analytics) across a CRM based multi-service business platform.

In embodiments, the methods and systems of registration pattern creation, configuration, use, and adaptation described herein may be further enabled through features of a host CRM, such as CRM-specific application programming interfaces (APIs) and the like. One or more CRM-specific APIs may facilitate uniform execution of read and/or write operations on objects in the CRM independently of a type of the objects. In example embodiments, use of such APIs with the methods and systems of registration patterns described herein may facilitate dynamically enabling use of several CRM object types for a specific use case (e.g., a CRM project, CRM-powered application, etc., some of which are described herein) using unmodified use case software/code. Further such us of the APIs may avoid redeployment and/or modification of software/code, CRM-specific data structures, etc. Benefits of such CRM-specific API functionality may include, among other things: (i) improved performance when using the CRM as compared to services that require such modification/adaptation; (ii) efficient CRM-independence of use case/user/service; (iii) efficient reuse of existing code thereby reducing the amount of use case-specific code to be maintained; and (iv) uniformity and consistency of CRM object structures, interface methods, and codebase that results in easier platform maintenance, debugging, etc.

Registration patterns (definitions and/or associations) may be established based on a range of factors and aspects of the CRM as well as consuming applications/processes. In example embodiments, when a new object type is defined in the CRM, such as a transaction-type object, one or more transaction type object registration definitions may be configured in the CRM. In example embodiments, a transaction type object registration definition may be created in the CRM for each consuming application so that each consuming application may seamlessly use/process the new object type by referring to its transaction type object registration definition. Further in this example, one or more registration associations may be defined and stored in the CRM to facilitate monitoring CRM event activity and maintaining continuity within the CRM for events that may impact the transaction-type object. In another example, when a new consuming application (e.g., a compliance application) is to initiate access to the CRM, one or more compliance application-specific registration definitions (e.g., one for each type of object present in the CRM contemporaneous with the compliance application initiating access) may be created and stored in the CRM.

In example embodiments, registration patterns may adhere at least in part to requirements of other objects in the CRM, such as use of syntax, taxonomy, structural elements like field definitions, etc. In this regard, registration patterns may be defined, instantiated, and maintained in the CRM through one or more pre-existing interfaces, portals, applications, wizards, etc. through which objects, object types and the like may be defined, instantiated, and maintained in the CRM. Use of preexisting interfaces, tools, etc. may reduce complexity of a multi-service business platform, may reduce training time, may increase the likelihood that registration patterns may be adopted by users of the multi-service business platform, etc.

Registration patterns may be configured with a range of functionality, including without limitation, mapping source object field values to consuming application fields, reformatting source object field values to conform with consuming application formatting needs, establishing and/or signaling use of default values for consuming application data that may not be provided by a source object, indicating whether an object type may be used (activated) or may not be used (deactivated) by the consuming application, etc. Further, records (e.g., registration definition elements) may be created in the CRM to register other records (e.g., email objects, contact objects, etc.) with, for example CRM-powered applications. In this way, and optionally when combined with CRM-specific APIs, a registration pattern-enabled CRM may self-adapt for a wide variety of uses without, among other things, external sets of mappings of source object content to consumer (e.g., application) content or CRM-specific access code created content for and/or associated with each individual use case/application. In example embodiments, a registration pattern-enabled CRM may facilitate mapping attributes of source objects to specific fields required by any application that accesses (e.g., reads or writes) the CRM. Therefore, not only may the CRM be constructed and operated optimally for meeting requirements of a hosting multi-service business platform, but the CRM may be made accessible to external services by merely creating registration patterns for the external service.

By storing the registration patterns as object/elements in the CRM, the CRM may become its own configuration and adjustment mechanism. This enables independence of the CRM so that there may be no other system, no other interfaces, and no need for any system, application, third-party, or the like knowing about the details of objects in the CRM. Each registration pattern that is created for each object (e.g., object type) may hold the details about how to use the information in the object in the CRM to satisfy the system/application/third-party information requirements.

In example embodiments, a registration pattern map may attribute properties of the source object (e.g., Email Sent Date) to generic fields required by the application to which the source object data may be applied/used (e.g., start date for an event in the calendar). This pattern may be used with different applications/systems (e.g., calendar system and/or campaign system). In example embodiments, creating registration patterns and some customized objects may be accomplished through the same process and the same portal, such as the same form filling API used for customized objects. In example embodiments, it may be the same API, even though the logic performed by the API (e.g., in the background) may change. However, a standard object may be stored with a different data server than a custom object or registration pattern, due at least in part different freight limiting and other aspects that may not be needed for customized objects. In example embodiments, when trying to register a custom object, the system may execute logic for customized objects. When trying to create standard objects, the system may execute logic required for the standard objects. However, the interface (e.g., representation of the registration element to the user) may be the same. In example embodiments, the system may store the same kind of information for both of these (e.g., registration elements and customized objects).

In embodiments, a registration pattern (e.g., registration definition element, registration association element, etc.) may be configured through a process that may include several actions. One such action may include identifying a target consumer application/user/project of information stored in objects in the CRM. Another such action may include identifying content types that may be required for use by the target consumer application/user, such as dates, links, etc. An example target consumer of CRM object information may include CRM-powered applications, such as a calendar application/service, a performance monitoring (e.g., analytics) application/service, an ingestion application/service, a CRM access application/service (e.g., CRM-access API and the like), a data conversion service, a third-party application, etc. When one or more content types may be identified for the target consumer application/service, corresponding source fields for one or more (optionally all) types of CRM objects may be determined. As an example, a start_date field of a calendar application may require a particular source date content to ensure that the calendar application may populate aspects of the source objects from the CRM in the proper date. Information in a campaign-type object in the CRM may include several date fields (e.g., a date field that defines a trial period, a date field that defines when the campaign object was created, another date field for when a targeted advertising action of the campaign is to start, etc.). In example embodiments, a date field of the campaign-type object may be determined to correspond to the start_date field of the calendar application through use of automated and/or at least partially with manual activity. Date fields of other object types in the CRM may be determined to correspond to a start_date field of a calendar application. This process may be repeated for each target consumer application/user in combination with each object type defined in the CRM.

In embodiments, a process to create a registration pattern, such as a registration definition may include identifying content types (e.g., dates, links, etc.) that may be required for a target consumer application/portal/user, such as a marketing calendar application, etc. The process may include, for each CRM object type, determining which source field may correspond to each of the identified content types. From this information, a CRM compatible object/element, such as a target consumer-specific registration definition that facilitates the correspondence may be arranged in a form that makes plain which source object and field corresponds to which target consumer content field. In embodiments, a process by which the registration definition created as described above, or otherwise created, copied, accessed, provided, or the like may be used and may include accessing the target consumer-specific registration definition. Based on object type properties of the retrieved registration definition, the system may receive/retrieve object(s) of the identified type from the CRM to be processed. In example embodiments, a record, optionally stored in or in association with the CRM (e.g., in an object processing tracking history), may identify object(s) of the CRM that may have already been processed. For each object of the identified object type accessed, the registration definition content (e.g., the map of object properties to target-user properties) may be used to map source object field values into target consumer-required fields. The resulting data may be used by the target consumer/application to perform its function, such as populate a calendar for rendering in a user interface.

In example embodiments, comparable properties on different object types may be given the same identifier (e.g., object ID), although that may not be required. A first object may define the ID property with one name, but another object may define the ID property with a different name. The methods and systems of registration patterns may allow two different properties in two different objects to have the same name, while ensuring that each is mapped properly when each object is processed by its corresponding registration definition (e.g., for use by an application such as the calendar application).

In embodiments, query registration definitions may be transformed into standard representations for a calendar application. Example embodiments may include using a calendar system to look up registration definitions (e.g., look for data properties such as name and/or what is shown in the calendar including start date). In example embodiments, registration definition required fields may include primary ID, definition name, definition type, properties such as start date, etc. for use with the calendar system. In embodiments, an API may be configured for use as an interface between an application (e.g., calendar) and the CRM. An example may include an API used to fetch registration definitions (e.g., blog posts CRM objects which may be JSON representing blog posts objects in the CRM). This example may include an API that may feed data from the CRM to be transformed and formatted for an application (e.g., calendar application). This example may include a list of registration definitions from a CRM that may include configurations and rules that may be applied as part of obtaining a standard calendar event (e.g., feed of data pre-transformation and post-transformation for each registration definition). In embodiments, there may be a level of common functionality to registration patterns that may be applied across objects, applications, and CRM elements in general. In example embodiments, an application may feed off data from the CRM. A registration pattern may be keyed to one of several types of objects. In embodiments, a registration pattern may have a set of data that may apply to any use of the registration pattern. Also, a registration pattern for a calendar application may define a set of “must have” fields such as start date as described herein. This example of a data item in the set of data that, while it may apply to any use of the registration pattern, may be accompanied by application-specific transformation and configuration data.

In embodiments, a calendar application use of registration patterns is described in the disclosure. Prior to use of a registration pattern by a marketing calendar application to render events on the calendar of different object/asset types, the application may fetch the relevant data from several objects in the CRM. In this example, the CRM may be a multi-service business platform CRM database that may include different types of CRM objects for several platform users. The calendar application may seek to render select assets for the users in one calendar view. Therefore, the calendar application may retrieve CRM object content from a range of asset types and user-specific objects and render the respective calendar events accordingly. For some examples, in addition to needing to discern specific portions of different types of assets for a single user, having to deal with several users may require a substantive amount of code development and maintenance that may cause a negative impact on the platform codebase, on the platform metrics, and on the overall platform performance. Further, in some examples, a lack of homogeneity may make onboarding new assets to the calendar tedious and error prone as more and more complexity may be added to the calendar application codebase. This greater complexity may contribute to overall platform performance degradation.

Use of the methods and systems of registration patterns may resolve and/or eliminate these complications, performance cost, and complexity. The example calendar application (and generally most such applications that access a CRM) may use fetching logic of the CRM. That fetching logic complexity may be reduced so that a single fetching logic (e.g., program code) may be used to fetch content from all different types of CRM objects or assets for all different user objects stored in the CRM. Typical operational activity of the platform, such as onboarding a new asset to the calendar (e.g., rendering a newly created campaign in the calendar and the like) has been turned from a tedious error-prone process that may result in impacting rendering of other assets into a simple registration definition creation process using CRM-object creation tools. This improvement may be exemplified by each registration element instance in a registration definition element being responsible for onboarding of a specific asset type. The registration element instance may contain at least a mapping of properties on the CRM object to fields on a common calendar event object. Prior to use of registration patterns, the mappings between specific assets and calendar events (e.g., between CRM object fields and calendar object fields) were statically coded for each asset. This required having several entities responsible for onboarding each individual asset type to be rendered in the calendar. With registration patterns, a single entity may be configured to receive a registration element instance with a corresponding CRM object and deliver a conforming calendar event data set that may be rendered by the calendar application.

Further, in this registration pattern example for use by a calendar application, a calendar application may request registration definition element(s) configured to facilitate onboarding of calendar events based on select object (types/assets) in the CRM, such as blog posts, landing pages, social media posts, etc. A CRM-interface portion of the calendar application, or optionally a CRM-interface service of the CRM such as a CRM-specific API and the like, may use the information that identifies each registration element instance in each registration definition element to identify assets in the CRM to be accessed. In example embodiments, a calendar application may target a specific CRM asset when requesting the registration definition element(s), such as when a user may adjust a view of the calendar to include an asset not currently rendered in the calendar. Content of the targeted assets may be retrieved and values from fields identified in a corresponding registration element instance may be selected and configured for delivery to the calendar application. Configuring these selected values may include generating a data set that attributes each selected value to a specific field/attribute of the calendar application. A value of the CAMPAIGN asset field “hs_campaign_start_date” for a selected CRM asset may be attributed to the calendar required field “startDateProperty”. The calendar then may use this value to render the CAMPAIGN asset on the proper date in the calendar.

Further, in the example, the MARKETING_EMAIL registration definition element instance may be enabled for use by the calendar or disabled for use. The value in the registration definition element instance entry labeled “isEnabled” may be used for such a purpose. When the entry labelled “isEnabled” given a value of “true” as depicted in FIG. REG02, then the calendar application may render CRM objects of the type “MARKETING_EMAIL”. If the same entry value was not “true” (e.g., “false”), then the calendar application may not render CRM objects of the type “MARKETING_EMAIL”. In embodiments, registration definitions may facilitate distinguishing between two different variants of an object type. The specific variant of object type “MARKETING_EMAIL” to which this registration definition applies may be an “email” variant as determined by the “crmObjectDisplayName” field. Rendering of other variants of “MARKETING_EMAIL” by the calendar application may be separately controlled.

A user interface is provided through which registration definitions for a calendar application may be selected for onboarding a corresponding CRM asset/object. The highlighted drop-down list may be used to select one or more asset types to be rendered in the calendar. Selection (e.g., checking a corresponding checkbox in the drop-down list) may cause a CRM fetching service to access a corresponding registration instance within a registration definition element for the calendar application. All of the available event types may be selected. For the remainder of this example, the event type is referenced. In example embodiments, the CRM fetching service may access corresponding registration instances for event type. In example embodiments, the fetching service (or the like) may proceed to retrieve data from each LAG object in the CRM, apply the registration instance mappings for a LAG object type, and deliver the resulting content to the calendar application. The result may include one or more lead generation rendered on the calendar. The processes described in this example may leave the source object(s) (e.g., all LAG-type objects) in the CRM database unchanged, while ensuring that each may be properly rendered in the calendar.

In embodiments, registration patterns may include a variant referred to herein as registration associations. Registration associations may facilitate, among other things, maintaining consistency across objects within a multi-service business platform database, such as a customer relationship management (CRM) database. Registration associations may facilitate adding new associations among objects and/or updating existing associations based on actions on or within the CRM. In example embodiments, existing associations may be cleared/removed or updated for maintaining consistency. In embodiments, registration associations may define one to one associations (among assets of the platform, such as objects of the platform) and one to many associations. In embodiments, registration association type patterns may allow associating an object with a different type of object, such as to a campaign. The example of one to one or one to many association may include associating one blog post to one campaign in a one to one registration association relationship. In an example of changing a one-to-one relationship association, if a blog post, e.g., “the best blog post ever” is associated to a first campaign, an association status for this blog post may show that it is currently part of (e.g., associated with) this campaign. If that blog post association is changed, such as by attempting to associate it to a second campaign, through application of the methods and systems of registration association described herein, it may be removed from the first campaign because, in this example, one blog post may only be part of one campaign.

In embodiments, a many to many asset association may include association of a workflow. In this example, a user (or system process or other automated process and the like) may add a first workflow to a first campaign. If one were to add the first workflow to a second campaign, the system may accept this second association of the first workflow without removing it from the first campaign because, in this example, one workflow may be part of multiple campaigns. In embodiments, a control for whether or not an asset may be used in a one-to-many association may optionally be indicated by an association definition index value recorded in the registration association data structure. In an example of a registration data structure that uses a JSON syntax, this value may be retrieved from an “association ID” property of the registration association data structure.

In addition to handling asset association relationship modes (one-to-one and one-to-many), the association variants of registration patterns herein may be used by a CRM activity monitoring service of the platform that may be utilized to process updates to objects for consistency across the platform (e.g., updating of associations such as a blog post belongs to a particular campaign, or the particular campaign has a blog post as described in the disclosure). In example embodiments, a worker system may monitor for changes in the CRM (e.g., changes to registration definitions, campaigns, etc. that may require changes to associations). The registration association information from several object type-specific registration association element instances may be used (e.g., by the worker system) in determining specific changes (e.g., type of object, properties, and/or associations of the object) that may be required for consistency. The worker system may query a source of data that may include changes to one or more objects (e.g., a CRM ingestion/activity stream and/or log) for activity associated with an object type defined in one of several registration association element instances being used by the worker system to determine if certain properties have changes (e.g., value present in property may have changed). If CRM change activity matches the information in the registration association being used by the worker system, one or more objects (e.g., campaign objects) may need to be changed based on that property change (e.g., property change may be moving of blog post from one campaign to another campaign).

A worker system (e.g., a platform service and the like) may use registration elements as the worker system listens to a stream of change events in the CRM. Worker system may also be referred to as worker service. For each event, the worker system may monitor changes to one or more object values defined by a registration association for the object type identified in the event to determine among other things how the CRM may have changed, such as how a campaign associated with the object type identified in the event may have changed. If the campaign has changed, the worker system or service may attempt to update all the associations of the campaign and keep the CRM consistent. A registration element used by that worker service may identify a type of object and what fields of the object may be monitored for changes in the event stream. Based on changes in that field, the worker system may determine which associations should be updated, which ones should be cleared out, which new ones should be created, etc. In embodiments, the worker service or system may perform these association consistency updates independent of the object being a custom object or a standard core object. In example embodiments, how a registration element is structured (e.g., the property that it checks for and the like) may change for each different application/use.

In embodiments, one may use the registration associations for doing associations of assets with the campaign. In example embodiments, a registration may include a set of definitions for processing items. For example, an example registration may facilitate a worker service in determining if, in the CRM, any object of the type “automation platform flow” changes, and if a property (e.g., campaign GUID property “hs_campaign_guids”) specifically changes, then the value which may be present in the change event for that property may be associated with the object that has been changed. For example, an object of type “automation platform flow” that has changed may be considered. The value of a property may have changed (e.g., campaign GUID score changed). In example embodiments, the worker service may automatically do the association of the “automation platform flow” (which has changed) with the corresponding campaign. This example of registration patterns relates to managing of associations between objects in the CRM. A type of registration association data structure for use by a worker service may include only a few sets of fields such as fields relating to object type being monitored and the field being monitored.

In embodiments, there may be several applications that move assets in and out of campaigns. It may require monitoring and possible adjustment of the code of these applications such as making changes to keep the associations straight and up-to-date. The CRM may emit a constant stream of events. Every time anything changes such as a definition, an object, or an object instance, there may be an event in that stream. The worker service that uses registration associations may be monitoring the stream for all of these changes. For example, if a user took a blog post and moved it from a first campaign to a second campaign, that change may generate an event in the stream. The worker service may monitor (e.g., listen) for such an event and determine that the blog post had its campaign field updated to reflect the second campaign. The worker service may check the second campaign object (that may be defined in the updated campaign field in the blog post change event) and may make sure that the second campaign object reflects the new campaign assignment. In example embodiments, such a worker service or system may be a CRM internal tool to keep the associations between objects in the CRM up-to-date. Rather than changing the database in some examples, this worker system or service may be adjusting the association (e.g., changing the graph data). In example embodiments, applications may be changing the database and may also be updating at least portions of the CRM. This registration association-based worker service/system may monitor the portion of the CRM that may be changed to determine what else in the CRM may be impacted by the change, thereby centrally implementing the change across the CRM for objects and/or object types identified in the registration association employed by the worker service. This central implementation of CRM changes through use of registration associations may eliminate the need for requiring the change be made by every individual application that may make use of the CRM.

In example embodiments, registration patterns may include variations that may facilitate updating portions of the CRM based on monitored CRM events, such as activities of sources of changes to other portions of the CRM. An activity monitoring service may monitor CRM activity based on the registration association element. The activity monitoring service may look in the monitored activity for event content that may signify that an object type “LANDING_PAGE” is being targeted for some action (e.g., reading a value in the object, writing/updating a value of one or more fields in the object, etc. When the monitored event identifies the object type “LANDING_PAGE”, the event may be further evaluated/monitored to determine if a specific field or fields of the object type are being acted upon by the event. The registration association for the object type LANDING_PAGE indicates that actions taken in the event against object field “hs_campaign_name” are to be followed up for maintaining consistency in the CRM database. When the event reflects that the object field “hs_campaign_name” is being/has been assigned a value (which is optionally the same as the current value or may be a different value than a current value), action may be taken within the CRM to ensure consistency as required based on the change. In example, a registration association element may identify a “blog post” field of a “campaign” object for monitoring by a CRM event activity monitoring service. When a CRM event matches this registration association element, a new value in the “blog post” field that may be defined in the event may be used to update portions of the CRM database for maintaining consistency. Some applications that have access to the CRM may be making changes that require updating the CRM. The activity monitoring service may use registration associations to determine if the change being made requires other changes in the CRM for consistency. Such an approach may reduce the burden on such applications of ensuring that CRM database consistency is maintained. In example of use of registration association elements, information in the registration association may facilitate identifying what the CRM consistency application may need to do when a specific field in a specific object type is acted upon. In embodiments, a CRM activity event may detect where a value of an attribute in a CAMPAIGN object is changed in the CRM. There may be other CRMs that may be impacted by such a change. In embodiments, a CRM consistency service may use the change of object information identified in the association registration to query the CRM for other (e.g., related) objects that rely on the now changed object field content. As the CRM consistency service finds other impacted objects, it may change them so that the now changed object content may be propagated to the other related objects.

Benefits of registration patterns is that third-parties may not be forced to adhere to a unique standard (e.g., one that may be different than the third-party's standard) when third parties create their own (e.g., custom) objects and use them within the multi-service business platform CRM. This may relate to third-party CRM use/access examples. The methods and systems of registration patterns described herein may provide benefits to third-party CRM use and access. In an example, a customer may define a custom class CRM object that they have been using for a period of time (e.g., one or two years or more). In this example, when the customer finds a vendor (e.g., with a system/service that they want to use with their custom class CRM objects), there is no need for either the customer or the vendor to change their systems-both may keep their objects as they were and the vendor may keep their system in place. If the vendor or the customer uses the example registration pattern methods and systems, interfacing between the customer custom class CRM and the vendor may be done through automatically transforming data without requiring any new code to run. In example embodiments, registration patterns, such as registration definitions may allow for custom object use and creation by third parties. The registration patterns (and supporting CRM access APIs and the like) may be configured with external endpoints through which third parties may access the CRM for their own tools in order to, among other things, visualize custom registration patterns, create new elements or objects, update customized objects in the CRM, etc. Also, in example embodiments, a customer may operate an external CRM system and may want to use the systems and processes of registration patterns to map these external CRM objects to objects and/or services of the multi-service business platform CRM. This may be accomplished by defining a set of registration patterns that may facilitate mapping the external CRM object properties to internal CRM object properties and use this set of registration patterns during exchange of data between the systems. In example embodiments, exchange of data between a CRM and external systems may include transforming data based on applied registration patterns (e.g., registration definitions). Transforming may include converting objects (or portions thereof) in the external system to be compatible with objects (or corresponding portions thereof) in the CRM. Registration patterns may also facilitate transforming data for compatibility when transferring CRM objects to the external system.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments. Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object. Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method, comprising:
invoking a large language model to generate initial topics for contents of a corpus;
iteratively merging and removing overlapping topics of the initial topics to create a refined set of topics;
assigning topics from the refined set of topics to components of the contents, wherein a first topic is assigned to a first component of a content and a second topic is assigned to a second component of the content, and wherein multiple topics, including the first topic, are assigned to the first component;
invoking the large language model to iteratively assign subtopics to the content, wherein a topic is used as an anchor providing contextual awareness for subtopic generation;
generating a hierarchical topic structure including the topics and subtopics; and
utilizing the hierarchical topic structure to generate an analysis result.

2. The method of claim 1, comprising:
determining that a first initial topic and a second initial topic overlap based upon the first initial topic and the second initial topic having a semantic similarity above a first threshold and a linguistic difference above a second threshold, wherein the first initial topic is either removed from the initial topics or is merged into the second initial topic to create a distinct topic for inclusion within the hierarchical topic structure.

3. The method of claim 1, comprising:
executing a workflow with a series of prompts to control the large language model for generating the hierarchical topic structure.

4. The method of claim 1, comprising:
for a content:
determining topics that apply to text segments of the content;
extracting the text segments from the content; and
generating, utilizing the large language model, explanations and confidence scores for the topics.

5. The method of claim 1, comprising:
generating, utilizing large language model chain-of-thought reasoning, an explanatory justification for topic assignments within the hierarchical topic structure.

6. The method of claim 1, comprising:
performing context-aware subtopic generation using parent topics as context for generating a subtopic.

7. The method of claim 6, comprising:
for the topic:
parsing text of contents to which the topic is assigned; and
evaluating the text, using the large language model, to generate a subtopic.

8. The method of claim 6, comprising:
for the topic:
extracting components for which the topic is assigned across the corpus;
generating, utilizing the large language model, proposed subtopics from the components;
refining the proposed subtopics to generate refined subtopics; and
utilizing the proposed subtopics and the refined subtopics to assign and extract topics for the components.

9. The method of claim 6, comprising:
identifying one or more subtopics subdivided from the subtopic.

10. A computing device comprising:
a memory comprising machine executable code; and
a processor coupled to the memory, the processor configured to execute the machine executable code to cause the processor to perform operations comprising:
invoking a large language model to generate initial topics for contents of a corpus;
iteratively merging and removing overlapping topics of the initial topics to create a refined set of topics;
assigning topics from the refined set of topics to components of the contents, wherein a first topic is assigned to a first component of a content and a second topic is assigned to a second component of the content, and wherein multiple topics, including the first topic, are assigned to the first component;
invoking the large language model to iteratively assign subtopics to the content, wherein a topic is used as an anchor providing contextual awareness for subtopic generation;
generating a hierarchical topic structure including the topics and subtopics; and
utilizing the hierarchical topic structure to generate an analysis result.

11. The computing device of claim 10, wherein the operations comprise:
restricting potential subtopics to components of contents identified as being relevant to a parent topic for which the subtopics are being derived.

12. The computing device of claim 10, wherein the operations comprise:
performing iterative refinement of topics and subtopics for inclusion within the hierarchical topic structure using semantic reduction.

13. The computing device of claim 10, wherein the operations comprise:
inputting business context information into the large language model for generating topics and subtopics relevant to a business based upon the corpus of contents.

14. The computing device of claim 10, wherein the operations comprise:
utilizing the hierarchical topic structure to identify topics described in employee surveys.

15. The computing device of claim 10, wherein the operations comprise:
utilizing the hierarchical topic structure to identify topics associated with at least one of call transcripts, email, or support tickets stored within the corpus.

16. The computing device of claim 10, wherein the operations comprise:
utilizing the hierarchical topic structure to identify information associated with customer journeys of experiencing content related to a business; and
processing the information to identify factors leading to cancellation with the business.

17. A non-transitory machine readable medium comprising instructions for performing a method, which when executed by a machine, causes the machine to perform operations comprising:
invoking a large language model to generate initial topics for contents of a corpus;
iteratively merging and removing overlapping topics of the initial topics to create a refined set of topics;
assigning topics from the refined set of topics to components of the contents, wherein a first topic is assigned to a first component of a content and a second topic is assigned to a second component of the content, and wherein multiple topics, including the first topic, are assigned to the first component;
invoking the large language model to iteratively assign subtopics to the content, wherein a topic is used as an anchor providing contextual awareness for subtopic generation;
generating a hierarchical topic structure including the topics and subtopics; and
utilizing the hierarchical topic structure to generate an analysis result.

18. The non-transitory machine readable medium of claim 17, wherein the operations comprise:
utilizing the hierarchical topic structure to identify topics associated with at least one of call transcripts, email, or support tickets stored within the corpus;
utilizing the hierarchical topic structure to generate a hierarchical topic map of customer interactions for analyzing customer relationships and customer needs;
generating dynamic contact profiles within a customer relationship management database based upon the topics; and
predicting future customer needs based upon topic patterns identified from the topics.

19. The non-transitory machine readable medium of claim 17, wherein the operations comprise:
utilizing the hierarchical topic structure to automatically categorize and tag content hosted by a multi-service business platform.

20. The non-transitory machine readable medium of claim 17, wherein the operations comprise:
utilizing the hierarchical topic structure to track topic performance, identify trending topics, and predict future content opportunities of content to provide users.
